(19) United States
(12) Patent Application Publication
(10) Pub. No.: US 2026/0143296 A1
(43) Pub. Date: May 21, 2026

(54) LISTENER-CENTRIC ACOUSTIC MAPPING OF LOUDSPEAKERS FOR FLEXIBLE RENDERING

(71) Applicants: DOLBY LABORATORIES LICENSING CORPORATION, San Francisco, CA (US); DOLBY INTERNATIONAL AB, Dublin (IE)

(72) Inventors: Andrew Robert Owen, Normanhurst, NSW (AU); Timothy Alan Port, Drummoyne, NSW (AU); Benjamin Southwell, Gledswood Hills, NSW (AU); Tianheng Zhang, Sydney, NSW (AU); Mark R. P. Thomas, Walnut Creek, CA (US); Avery Bruni, San Francisco, CA (US); Chao Liu, Dublin, CA (US); Brian George Arnott, Wahroonga, NSW (AU); Jan-Hendrik Hanschke, Nuremberg (DE)

(73) Assignees: DOLBY LABORATORIES LICENSING CORPORATION, San Francisco, CA (US); DOLBY INTERNATIONAL AB, Dublin (IE)

(21) Appl. No.: 19/121,225

(22) PCT Filed: Nov. 6, 2023
(86) PCT No.: PCT/US2023/078817

§ 371 Date: Apr. 15, 2025

Related U.S. Application Data
(60) Provisional application No. 63/423,578, filed on Nov. 8, 2022.

(51) Int. Cl. H04S 7/00; H04R 1/02

(52) U.S. Cl. CPC H04S 7/303; H04R 1/028; H04S 7/301; H04R 2430/20; H04R 2499/11

(57) ABSTRACT

Some methods involve determining, based at least in part on sensor signals from a sensing device held by a person, direction data corresponding to a direction of each loudspeaker of a plurality of loudspeakers relative to a first position of the person. Some methods involve determining, based at least in part on microphone signals from the sensing device, range data corresponding to a distance travelled by each audio calibration signal of one or more audio calibration signals emitted by each loudspeaker of the plurality of loudspeakers and received by the sensing device, and calibrating, by the control system, an audio data rendering process based, at least in part, on the direction data and the range data.

### TECHNICAL FIELD

This disclosure pertains to audio processing systems and methods.

### BACKGROUND

Audio devices and systems are widely deployed. Although existing systems and methods for estimating acoustic scene metrics (e.g., audio device audibility) are known, improved systems and methods would be desirable.

### Notation and Nomenclature

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or by multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X−M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

Throughout this disclosure including in the claims, the term “couples” or “coupled” is used to mean either a direct or indirect connection. Thus, if a first device couples to a second device, that connection may be through a direct connection, or through an indirect connection via other devices and connections.

As used herein, a “smart device” is an electronic device, generally configured for communication with one or more other devices (or networks) via various wireless protocols such as Bluetooth, Zigbee, near-field communication, Wi-Fi, light fidelity (Li-Fi), 3G, 4G, 5G, etc., that can operate to some extent interactively and/or autonomously. Several notable types of smart devices are smartphones, smart cars, smart thermostats, smart doorbells, smart locks, smart refrigerators, phablets and tablets, smartwatches, smart bands, smart key chains and smart audio devices. The term “smart device” may also refer to a device that exhibits some properties of ubiquitous computing, such as artificial intelligence.

Herein, we use the expression “smart audio device” to denote a smart device which is either a single-purpose audio device or a multi-purpose audio device (e.g., an audio device that implements at least some aspects of virtual assistant functionality). A single-purpose audio device is a device (e.g., a television (TV)) including or coupled to at least one microphone (and optionally also including or coupled to at least one speaker and/or at least one camera), and which is designed largely or primarily to achieve a single purpose. For example, although a TV typically can play (and is thought of as being capable of playing) audio from program material, in most instances a modem TV runs some operating system on which applications run locally, including the application of watching television. In this sense, a single-purpose audio device having speaker(s) and microphone(s) is often configured to run a local application and/or service to use the speaker(s) and microphone(s) directly. Some single-purpose audio devices may be configured to group together to achieve playing of audio over a zone or user configured area.

One common type of multi-purpose audio device is an audio device that implements at least some aspects of virtual assistant functionality, although other aspects of virtual assistant functionality may be implemented by one or more other devices, such as one or more servers with which the multi-purpose audio device is configured for communication. Such a multi-purpose audio device may be referred to herein as a “virtual assistant.” A virtual assistant is a device (e.g., a smart speaker or voice assistant integrated device) including or coupled to at least one microphone (and optionally also including or coupled to at least one speaker and/or at least one camera). In some examples, a virtual assistant may provide an ability to utilize multiple devices (distinct from the virtual assistant) for applications that are in a sense cloud-enabled or otherwise not completely implemented in or on the virtual assistant itself. In other words, at least some aspects of virtual assistant functionality, e.g., speech recognition functionality, may be implemented (at least in part) by one or more servers or other devices with which a virtual assistant may communication via a network, such as the Internet. Virtual assistants may sometimes work together, e.g., in a discrete and conditionally defined way. For example, two or more virtual assistants may work together in the sense that one of them, e.g., the one which is most confident that it has heard a wakeword, responds to the wakeword. The connected virtual assistants may, in some implementations, form a sort of constellation, which may be managed by one main application which may be (or implement) a virtual assistant.

Herein, “wakeword” is used in a broad sense to denote any sound (e.g., a word uttered by a human, or some other sound), where a smart audio device is configured to awake in response to detection of (“hearing”) the sound (using at least one microphone included in or coupled to the smart audio device, or at least one other microphone). In this context, to “awake” denotes that the device enters a state in which it awaits (in other words, is listening for) a sound command. In some instances, what may be referred to herein as a “wakeword” may include more than one word, e.g., a phrase.

Herein, the expression “wakeword detector” denotes a device configured (or software that includes instructions for configuring a device) to search continuously for alignment between real-time sound (e.g., speech) features and a trained model. Typically, a wakeword event is triggered whenever it is determined by a wakeword detector that the probability that a wakeword has been detected exceeds a predefined threshold. For example, the threshold may be a predetermined threshold which is tuned to give a reasonable compromise between rates of false acceptance and false rejection. Following a wakeword event, a device might enter a state (which may be referred to as an “awakened” state or a state of “attentiveness”) in which it listens for a command and passes on a received command to a larger, more computationally-intensive recognizer.

As used herein, the terms “program stream” and “content stream” refer to a collection of one or more audio signals, and in some instances video signals, at least portions of which are meant to be heard together. Examples include a selection of music, a movie soundtrack, a movie, a television program, the audio portion of a television program, a podcast, a live voice call, a synthesized voice response from a smart assistant, etc. In some instances, the content stream may include multiple versions of at least a portion of the audio signals, e.g., the same dialogue in more than one language. In such instances, only one version of the audio data or portion thereof (e.g., a version corresponding to a single language) is intended to be reproduced at one time.

### SUMMARY

At least some aspects of the present disclosure may be implemented via one or more audio processing methods. In some instances, the method(s) may be implemented, at least in part, by a control system and/or via instructions (e.g., software) stored on one or more non-transitory media. Some methods involve determining, by a control system and based at least in part on sensor signals from a sensing device held or moved by a person, direction data corresponding to a direction of each loudspeaker of a plurality of loudspeakers relative to a first position of the person. In some examples, the sensor signals may be obtained when the sensing device is moved. Some methods involve determining, by the control system and based at least in part on microphone signals from the sensing device, range data corresponding to a distance travelled by each audio calibration signal of one or more audio calibration signals emitted by each loudspeaker of the plurality of loudspeakers and received by the sensing device. Some methods involve calibrating, by the control system, an audio data rendering process based, at least in part, on the direction data and the range data.

In some examples, the audio data rendering process may involve a flexible rendering process. In some such examples, the flexible rendering process may involve a center of mass amplitude panning process, a flexible virtualization process, a vector base amplitude panning process, or combinations thereof.

According to some examples, the sensor signals may include magnetometer signals, inertial sensor signals, radio signals, camera signals, or combinations thereof.

In some examples, the direction may be the direction of a loudspeaker relative to a direction in which the person is estimated to be facing. In some such examples, the direction in which the person is estimated to be facing may correspond to a display location.

According to some examples, the one or more audio calibration signals may be simultaneously emitted by two or more loudspeakers. In some such examples, the one or more audio calibration signals may not be audible to human beings. In some such examples, the one or more audio calibration signals may be, or may include, direct sequence spread spectrum (DSSS) signals utilizing orthogonal spreading codes. However, in some examples the one or more audio calibration signals may not be simultaneously emitted by two or more loudspeakers.

In some examples, the direction data may be, or may include, azimuth angles relative to the first position of the person. According to some examples, the direction data may be, or may include, altitude relative to the first position of the person. In some examples, the direction data may be determined based, at least in part, on acoustic shadowing caused by the person.

According to some examples, a distance between two or more loudspeakers may be known. Some such examples also may involve determining an absolute time of flight to the person of the audio calibration signals emitted by each loudspeaker to the first position of the person.

In some examples, a dimension of a room in which the plurality of loudspeakers resides is known or assumed. Some such examples also may involve determining an absolute time of flight to the person of the audio calibration signals emitted by each loudspeaker to the first position of the person.

Some disclosed methods may involve obtaining at least one additional set of direction data and range data at a second position of the person. Some such examples also may involve determining an absolute time of flight to the person of the audio calibration signals emitted by each loudspeaker to the first and second positions of the person.

Some disclosed methods may involve determining that the sensing device is pointed in the direction of a loudspeaker at a time during which user input may be received via the sensing device. According to some such examples, the user input may involve a mechanical button press or touch sensor data received from a touch sensor. Some such examples also may involve providing an audio prompt, a visual prompt, a haptic prompt, or combinations thereof, to the person indicating when to provide the user input to the sensing device.

Some disclosed methods may involve obtaining an additional set of direction data, an additional set of range data, or both, responsive to a temperature change in an environment in which the plurality of loudspeakers resides.

In some examples, determining the direction data, the range data, or both, may be based at least in part on one or more known or inferred spatial relationships between the sensing device and a head of the person when the sensor signals and the microphone signals are being obtained.

Some disclosed methods may involve associating an audio calibration signal with a loudspeaker based at least in part on one or more signal-to-noise ratio (SNR) measurements.

Some disclosed methods may involve performing a temporal masking process on the microphone signals based, at least in part, on received orientation data.

Some disclosed methods may involve updating, by the control system, a previously-determined map including loudspeaker locations relative to a position of the person based, at least in part, on the direction data and the range data.

According to some examples, the sensor signals may be obtained when the sensing device is pointed in the direction of a loudspeaker, when the sensing device is rotated from the direction of one loudspeaker to the direction of another loudspeaker, when the sensing device is translated from the direction of one loudspeaker to the direction of another loudspeaker, or combinations thereof.

In some examples, determining the range data may involve determining a time of arrival of each audio calibration signal of the one or more audio calibration signals emitted by each loudspeaker of the plurality of loudspeakers and received by the sensing device, determining a level of each audio calibration signal of one or more audio calibration signals emitted by each loudspeaker of the plurality of loudspeakers and received by the sensing device, or both.

Some disclosed methods may involve causing, at a time during which user input is received via the sensing device, each loudspeaker of the plurality of loudspeakers to transmit subaudible direct sequence spread spectrum (DSSS) signals. Some such examples also may involve determining updated range data based on the subaudible DSSS signals. Some such examples also may involve updating, by the control system, a previously-determined position of the person based, at least in part, on the updated range data. Some such examples also may involve determining updated direction data based on the subaudible DSSS signals and updating, by the control system, the previously-determined position of the person based, at least in part, on the updated direction data.

At least some aspects of the present disclosure may be implemented via apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Some additional aspects of the present disclosure may be implemented via one or more methods. In some instances, the method(s) may be implemented, at least in part, by a control system and/or via instructions (e.g., software) stored on one or more non-transitory media.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of an audio environment.

FIG. 1B is a block diagram that shows examples of components of an apparatus capable of implementing various aspects of this disclosure.

FIG. 2 is a block diagram that shows examples of audio device elements according to some disclosed implementations.

FIG. 3 shows an example of a one-tap calibration process.

FIG. 4 is a block diagram that shows additional examples of audio device elements according to some disclosed implementations.

FIG. 5 shows an example of acoustic shadowing.

FIG. 6A shows examples of raw direction data that was logged during a one-tap calibration process.

FIG. 6B shows examples of temporal masks based on clustered directional data.

FIGS. 7A, 7B and 7C show demodulated DSSS signals corresponding to the temporal masks shown in FIG. 6B.

FIG. 8A shows a listener in two different positions within an audio environment.

FIG. 8B shows an alternative calibration process that requires multiple user inputs to generate a map.

FIG. 9 shows a block diagram of a signal chain for an (n+1)-tap calibration process according to one example.

FIG. 10 shows example blocks of an alternative signal processing chain.

FIG. 11 is a graph that shows examples of the levels of a content stream component of the audio device playback sound and of a DSSS signal component of the audio device playback sound over a range of frequencies.

FIG. 12 is a graph that shows examples of the powers of two DSSS signals with different bandwidths but located at the same central frequency.

FIG. 13 is a flow diagram that outlines another example of a disclosed method.

FIGS. 14A and 14B show examples of an alternative approach that involves deriving direction data using at least two acoustic measurements alone, where the location of the handheld device, relative to at least one loudspeaker, is known.

### DETAILED DESCRIPTION OF EMBODIMENTS

Flexible rendering is a playback solution which delivers immersive audio experiences from a constellation of speakers that can be flexibly placed around the room, not necessarily conforming to a canonical surround sound layout such as Dolby 5.1 or 7.1. A larger number of speakers allows for greater immersion, because the spatiality of the media presentation may be leveraged. To configure a flexible renderer, a map needs to be created that describes the layout of the speakers and optionally the position of a listener.

Some previously-deployed mapping solutions aim to form a complete, absolute map of all loudspeaker positions, which provides more information than is minimally necessary for the implementation of flexible rendering. Some previously-deployed user-driven placement mapping solutions usually carry a significant trade-off between mapping accuracy and user effort required. Loudspeaker placement applications that require a significant amount of user effort, such as those that involve the user clicking and dragging speakers onto a map, can potentially yield high-accuracy loudspeaker position maps, subject to the user's measurement accuracy. On the other hand, approximate zone-based mapping requires minimal user effort but produces very inaccurate maps.

Some previously-deployed acoustic mapping solutions for flexible rendering have focused on the use of microphones within the speakers, such as in the case of smart speakers, to build a map of a loudspeaker constellation instead of being listener-centric. Such solutions are constrained in their scope of support to loudspeakers with in-built microphones, such as smart speakers. In contrast, the methods disclosed herein do not require any sound capturing apparatus within the loudspeakers, thereby expanding the scope of mapping beyond smart speakers to all loudspeakers in general.

This disclosure provides a set of listener-centric approaches for creating such maps—or for modifying existing maps—by combining or “fusing” microphone and sensor data such as magnetometer data, inertial sensor data (such as accelerometer data and/or gyroscope data), camera data, or combinations thereof. In this discussion, the term “compass data” refers to the heading of the sensing device and may be determined by a single device such as, but not limited to, a compass or a magnetometer, or by combining multiple sensors, such as but not limited to, an inertial sensor and a magnetometer, for example by using a sensor fusion process such as a Kalman Filter or a variant thereof. These processes may be aided by a priori knowledge and models of the dynamics involved.

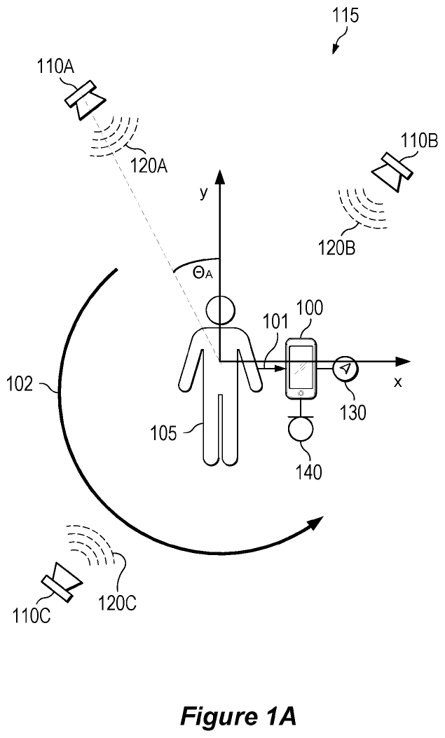

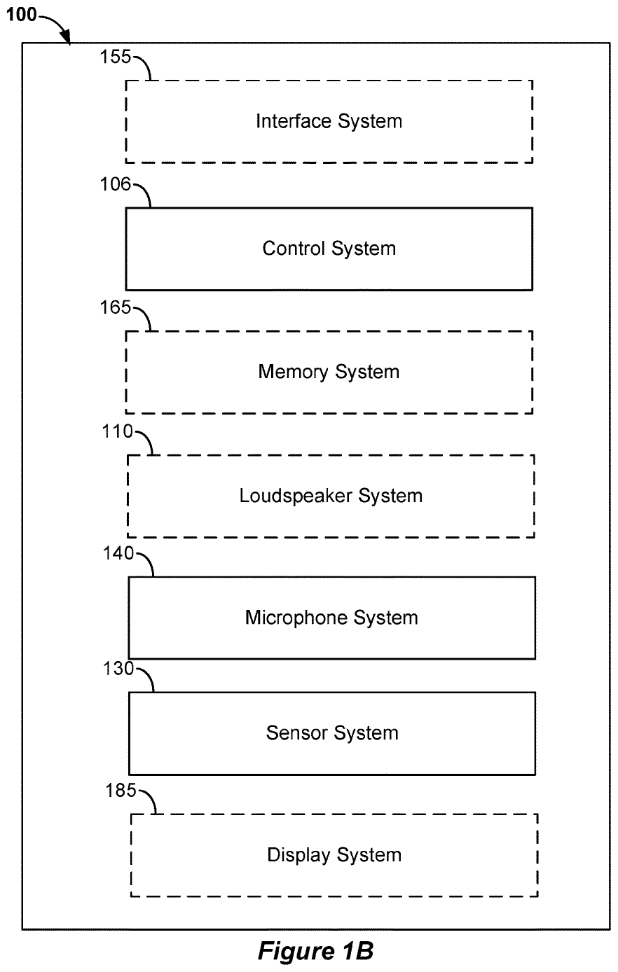

FIG. 1A shows an example of an audio environment. As with other figures provided herein, the types and numbers of elements shown in FIG. 1A are merely provided by way of example. Other implementations may include more, fewer and/or different types and numbers of elements. For example, other audio environments 115 may include more than three loudspeakers.

FIG. 1A shows an example of a listener-centric, semi-automatic calibration system in an audio environment 115. In this example, a user 105—also referred to herein as a person or a listener—is holding a mobile device 100 that includes a directionally-sensitive sensor system 130 and a microphone system 140. The mobile device 100 is an example of what may be referred to herein as a “sensing device.” The mobile device 100 may be cellular telephone, a remote control device, a tablet device, or another type of mobile device. The sensor system 130 may include one or more accelerometers, one or more magnetometers, one or more gyroscopes, one or more accelerometers-which may collectively be referred to an inertial measurement unit (IMU)-one or more cameras, one or more radios or combinations thereof. In some examples, the sensor system 130 may be configured for light detection and ranging (LiDAR).

According to this example, the user 105 provides input 101 to the mobile device 100 to initiate a calibration process. Calibration signals 120A-C then play out from all loudspeakers 110A-C in the constellation. In some examples, the calibration signals 120A-C may be audio signals that are included with rendered audio content that is played back by the loudspeakers 110A-C. Simultaneously, sound data—including the calibration signals 120A-C—is collected by the microphone system 140. In this example, the user 105 is required to re-position (rotate and/or translate, as indicated by the arrow 102) the mobile device 100 for the collection of azimuth data. Collecting the azimuth data may involve obtaining azimuth angles for each of the loudspeakers 110A-C in a loudspeaker plane, in a listener plane, etc. In the example shown in FIG. 1A, the azimuth angle Θ_{A} corresponding to the loudspeaker 100A is measured relative to the y axis of a coordinate system having x and y axes parallel to the floor of the audio environment 115 and having its origin inside of the user 105. In other examples, the azimuth angles may be measured relative to the x axis or to another axis. In some such examples, the mobile device 100 may include a user interface system. A control system of the mobile device 100 may be configured to prompt the user 105, via the user interface system, to position and re-position the mobile device 100 for the collection of azimuth data.

Various examples of calibration processes are disclosed in detail herein. In some examples, a control system of the mobile device 100 may be configured to perform some or all of the calibration process(es). Alternatively, or additionally, one or more other devices may be configured to perform some or all of the calibration process(es). In some such examples, one or more servers or one or more other devices, such as a television, a laptop computer or a smart home hub, may be configured to perform some or all of the calibration process(es), based at least in part on data obtained by the mobile device 100.

FIG. 1B is a block diagram that shows examples of components of an apparatus capable of implementing various aspects of this disclosure. As with other figures provided herein, the types and numbers of elements shown in FIG. 1B are merely provided by way of example. Other implementations may include more, fewer and/or different types and numbers of elements. According to some examples, the apparatus 100 may be configured for performing at least some of the methods disclosed herein. In some implementations, the apparatus 100 may be, or may include, one or more components of an audio system. For example, the apparatus 100 may be an audio device, such as a smart audio device, in some implementations. In other examples, the apparatus 100 may be a mobile device (such as a cellular telephone or a remote control), a laptop computer, a tablet device, a television or another type of device.

In the example shown in FIG. 1A, the mobile device 100 is an instance of the apparatus 100 of FIG. 1B. According to some examples, the audio environment 100 of FIG. 1A may include an orchestrating device, such as what may be referred to herein as a smart home hub. The smart home hub (or other orchestrating device) may be an instance of the apparatus 100. In some implementations, one or more of the loudspeakers 110A-110C may be capable of functioning as an orchestrating device.

According to some alternative implementations the apparatus 100 may be, or may include, a server. In some such examples, the apparatus 100 may be, or may include, an encoder. Accordingly, in some instances the apparatus 100 may be a device that is configured for use within an audio environment, such as a home audio environment, whereas in other instances the apparatus 100 may be a device that is configured for use in “the cloud,” e.g., a server.

In this example, the apparatus 100 includes a microphone system 140, a control system 106 and a sensor system 180. The microphone system 140 includes one or more microphones. According to some examples, the microphone system 140 includes an array of microphones. The array of microphones may, in some instances, be configured for receive-side beamforming, e.g., according to instructions from the control system 106. In some examples, the array of microphones may be configured to determine direction of arrival (DOA) and/or time of arrival (TOA) information, e.g., according to instructions from the control system 106. Alternatively, or additionally, the control system 106 may be configured to determine direction of arrival (DOA) and/or time of arrival (TOA) information, e.g., according to microphone signals received from the microphone system 140.

In some implementations, the control system 106 may be configured for performing, at least in part, the methods disclosed herein. The control system 106 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 106 may reside in more than one device. For example, in some implementations a portion of the control system 106 may reside in a device within one of the environments depicted herein and another portion of the control system 106 may reside in a device that is outside the environment, such as a server, a mobile device (e.g., a smartphone or a tablet computer), etc. In other examples, a portion of the control system 106 may reside in a device within one of the environments depicted herein and another portion of the control system 106 may reside in one or more other devices of the environment. For example, control system functionality may be distributed across multiple smart audio devices of an environment, or may be shared by an orchestrating device (such as what may be referred to herein as a smart home hub) and one or more other devices of the environment. In other examples, a portion of the control system 106 may reside in a device that is implementing a cloud-based service, such as a server, and another portion of the control system 106 may reside in another device that is implementing the cloud-based service, such as another server, a memory device, etc. The interface system 155 also may, in some examples, reside in more than one device.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 165 shown in FIG. 1B and/or in the control system 106. Accordingly, various innovative aspects of the subject matter described in this disclosure can be implemented in one or more non-transitory media having software stored thereon. The software may, for example, include instructions for controlling at least one device to perform some or all of the methods disclosed herein. The software may, for example, be executable by one or more components of a control system such as the control system 106 of FIG. 1B.

The sensor system 130 may include one or more accelerometers, one or more magnetometers, one or more gyroscopes, one or more cameras, one or more radios or combinations thereof. In some implementations, the sensor system 130 may include one or more touch sensors, gesture sensors, motion detectors, etc. According to some implementations, the sensor system 130 may include one or more cameras. In some implementations, the cameras may be free-standing cameras. In some examples, one or more cameras of the sensor system 130 may reside in a smart audio device, which may be a single purpose audio device or a virtual assistant. In some such examples, one or more cameras of the sensor system 130 may reside in a television, a mobile phone or a smart speaker. In some examples, the apparatus 100 may be configured to receive sensor data for one or more sensors residing in one or more other devices in an audio environment via the interface system 155.

The interface system 155—when present—may, in some implementations, include a wired or wireless interface that is configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 155 may, in some implementations, be configured for exchanging control information and associated data with audio devices of the audio environment. The control information and associated data may, in some examples, pertain to one or more software applications that the apparatus 100 is executing.

The interface system 155 may, in some implementations, be configured for receiving, or for providing, a content stream. The content stream may include audio data. The audio data may include, but may not be limited to, audio signals. In some instances, the audio data may include spatial data, such as channel data and/or spatial metadata. Metadata may, for example, have been provided by what may be referred to herein as an “encoder.” In some examples, the content stream may include video data and audio data corresponding to the video data.

The interface system 155 may include one or more network interfaces and/or one or more external device interfaces (such as one or more universal serial bus (USB) interfaces). According to some implementations, the interface system 155 may include one or more wireless interfaces, e.g., configured for Wi-Fi or Bluetooth™ communication.

The interface system 155 may, in some examples, include one or more devices for implementing a user interface, such as one or more microphones, one or more speakers, a display system, a touch sensor system and/or a gesture sensor system. In some examples, the interface system 155 may include one or more interfaces between the control system 106 and a memory system, such as the optional memory system 165 shown in FIG. 1B. However, the control system 106 may include a memory system in some instances. The interface system 155 may, in some implementations, be configured for receiving input from one or more microphones in an environment.

In some implementations, the apparatus 100 may include the display system 185 shown in FIG. 1B. The display system 185 may include one or more displays, such as one or more light-emitting diode (LED) displays. In some instances, the display system 185 may include one or more organic light-emitting diode (OLED) displays. In some examples, the display system 185 may include one or more displays of a smart audio device. In other examples, the display system 185 may include a television display, a laptop display, a mobile device display, or another type of display. In some examples wherein the apparatus 100 includes the display system 185, the sensor system 130 may include a touch sensor system and/or a gesture sensor system proximate one or more displays of the display system 185. According to some such implementations, the control system 106 may be configured for controlling the display system 185 to present one or more graphical user interfaces (GUIs). In some examples, a user interface system of the apparatus 100 may include the display system 185, a touch sensor system and/or a gesture sensor system proximate one or more displays of the display system 185, the microphone system 140, the loudspeaker system 110, or combinations thereof.

According to some implementations, the apparatus 100 may include the optional loudspeaker system 110 shown in FIG. 1B. The optional loudspeaker system 110 may include one or more loudspeakers, which also may be referred to herein as “speakers” or, more generally, as “audio reproduction transducers.” In some examples (e.g., cloud-based implementations), the apparatus 100 may not include a loudspeaker system 110.

According to some such examples the apparatus 100 may be, or may include, a smart audio device. In some such implementations the apparatus 100 may be, or may include, a wakeword detector. For example, the apparatus 100 may be, or may include, a virtual assistant.

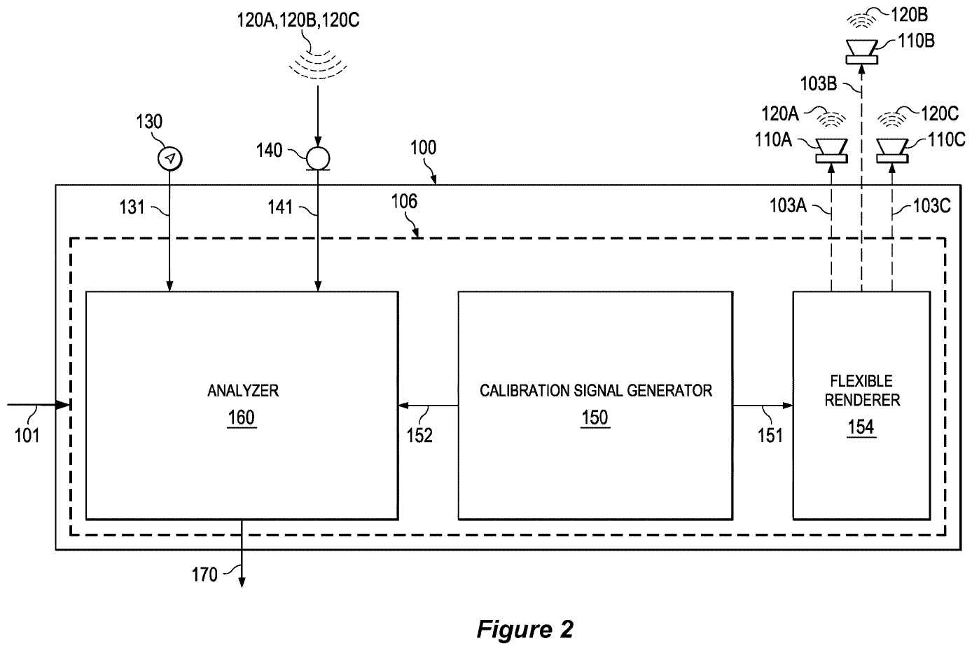

FIG. 2 is a block diagram that shows examples of audio device elements according to some disclosed implementations. As with other figures provided herein, the types and numbers of elements shown in FIG. 2 are merely provided by way of example. Other implementations may include more, fewer and/or different types and numbers of elements. In this example, the apparatus 100 of FIG. 2 is an instance of the apparatus 100 that is described above with reference to FIGS. 1A and 1B.

FIG. 2 shows high-level examples of device components configured for implementing a procedure to derive parameters for determining a map suitable for implementing a flexible rendering process in an audio environment. In this example, FIG. 2 shows the following elements:
131—direction data, including azimuth data;
141—microphone signals;
150—calibration signal generator;
151—calibration signal per loudspeaker;
152—calibration signal parameters per loudspeaker, such as a seed or code;
154—flexible renderer;
160—data analyzer; and
170—results for a current loudspeaker layout.

In this example, the calibration signal generator 150, the flexible renderer 154 and the analyzer 160 are implemented by an instance of the control system 106 of FIG. 1B. In some alternative examples, one or more of the components of the apparatus 100 shown in FIG. 2 may be implemented by a separate device.

Various examples of calibration signals that may be generated by the calibration signal generator 150 are disclosed herein. In some examples, the flexible renderer 154 may be configured to implement center of mass amplitude panning (CMAP), flexible virtualization (FV), vector-based amplitude panning (VBAP), another flexible rendering method, or combinations thereof. In this example, the analyzer 160 is configured to produce the results 170. According to some examples, the results 170 may include estimates of the following:
(1) Range data corresponding to the distance travelled by each of the audio calibration signals 120A-120C played back by the loudspeakers 110A, 110B and 110C, and received by the apparatus 100. The range data may, for example, be determined according to the time of arrival of each audio calibration signal; and
(2) The direction of loudspeakers with respect to the listener position.

In some examples, ToA-based range data (1) may be estimated by the control system 106 according to microphone signals 141 from the sensing device 100. The control system 106 may be able to determine, based on the microphone signals 141, the ToA-based range data(1).

In some examples, the range may be a relative range from the speakers to the listener, whereas in other examples the range may be an absolute range from the speakers to the listener. In some examples, if a relative range is derived, the relative range can then be used by the flexible renderer by assuming a fixed distance or delay for one of the speakers to the listener (for example, 2 m). In some other examples, if the relative range is in the form of a relative time delay at the listener's position, the relative time delay can be used directly by the flexible renderer without converting to a distance. In such examples, the flexible renderer may use a relative time delay at the listener's position to correct for time of flight differences.

According to some examples, direction data (2) may be estimated by the control system 106 according to sensor signals from the apparatus 100 when the apparatus 100 is held by the user 105. The direction data may correspond to a direction of each of the loudspeakers 110A-110C relative to a position of the apparatus 100, which may be used as a proxy for the position of the user 105. The sensor signals may be obtained when the sensing device 100 is moved. For example, the sensor signals may be obtained when the sensing device 100 is pointed in the direction of a loudspeaker, when the sensing device is rotated from the direction of one loudspeaker to the direction of another loudspeaker, when the sensing device is translated from the direction of one loudspeaker to the direction of another loudspeaker, or combinations thereof. In some examples, the location of the sensing device 100 may be used as a proxy for the location of the user 105 (not shown), a proxy for the location of the user's head, etc. Some examples may involve applying a known or assumed relationship between the location of the sensing device 100 the location of one or more parts of the user's body.

In some examples, the results 170 may include estimates of:
(3) Range data corresponding to the distance travelled by each of the audio calibration signals 120A-120C played back by the loudspeakers 110A, 110B and 110C, and received by the apparatus 100, based on the level or relative EQ of the loudspeakers within a layout, which may be referred to herein as level-based range estimates (3). In some examples, the level-based range estimates (3) may be estimated by the control system 106 according to microphone signals 141 from the sensing device 100.

According to this example, the calibration signal generator 150 generates a calibration signal 151 with a different set of signal parameters for each of the loudspeakers 110A-110C. In this example, the calibration signals 151 are provided to the flexible renderer 154 and injected into rendered playback content by the flexible renderer 154, forming the rendered calibration signals 103A, 103B and 103C for each of the loudspeakers 110A, loudspeakers 110B and loudspeakers 110C, respectively. In some examples, the calibration signals 151 may be optionally masked by playback content. In this example, the rendered calibration signals 103A, 103B and 103C are played out by the loudspeakers 110A-110C into the shared acoustic space as the calibration signals 120A, 120B and 120C, and are recorded by the microphone system 140. During the same time interval, the sensor system 130 collects azimuth data across a range of angles sufficient to cover all of the loudspeakers 110A-110C. In some examples, the sensor system 130 may measure altitude in cases where the speakers are not in the listener plane, for example height speakers.

In some examples of the calibration process, the user 105 may only provide input 101 once to initiate “one-tap calibration,” after which the user may be required to rotate and/or translate the apparatus as directed by the apparatus 100—or by one or more other devices, such as one or more of the loudspeakers 110A-110C, a display device in the audio environment, etc.—while the calibration signal is playing. In other examples, the user 105 may be required to provide input 101 to the apparatus 100 for each loudspeaker individually, for example by pressing a button, touching a virtual button of a GUI, etc., when pointing to each loudspeaker. Such examples may be referred to herein as “n+1-tap calibration,” with n denoting the number of loudspeakers.

According to this example, the microphone signals 141 and direction data 131 are fed into the analyzer 160. In some examples, the analyzer 160 utilizes correlation analysis based on the knowledge of which signal parameter 152 belongs to which of the loudspeakers 110A-C to deduce the latency per device for ToA-based range data (1) and perceived level-based range estimates (3). In some one-tap calibration embodiments, direction data 131 is aligned and combined with the microphone data 141 and knowledge of signal parameter 152 per loudspeaker 110A-C, in order to identify each loudspeaker and derive the direction per loudspeaker (2). In some n+1-tap calibration embodiments, the direction data 131 per loudspeaker may be recorded each time the user 105 presses a button, touching a virtual button of a GUI, etc., based upon the loudspeaker towards which the apparatus 100 is being pointed.

In some examples, such as simultaneous playback examples, a mapping process may require playback to be synchronized across all loudspeakers. In some examples, direction (at least azimuth) and sound capture may occur in the same clock domain. However, in other examples, direction and sound capture data may occur in different clock domains and may later be time-aligned. Some implementations may function with random delays between playback start and capture start, as would be the case if the processing, rendering, and analysis applications were running on a remote server.

### Example: One-Tap Calibration Process

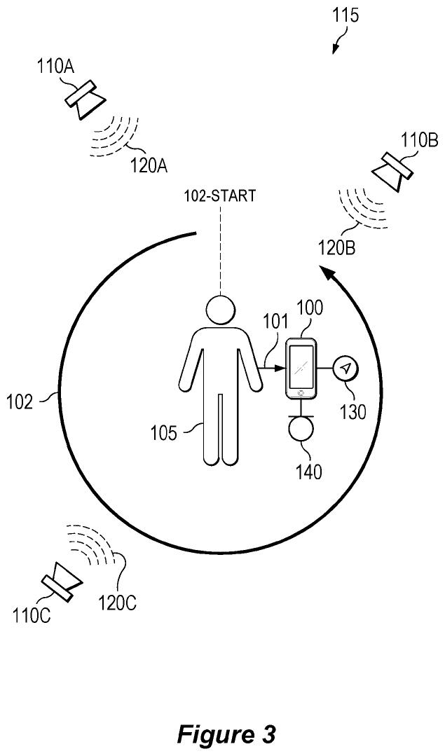

FIG. 3 shows an example of a one-tap calibration process. FIG. 3 shows a calibration process that requires the user 105 to “tap once”—or otherwise provide input 101 to—the apparatus 100 to initiate calibration. According to this example, after the one-tap process is initiated, the apparatus 100 provides prompts for the user 105 to re-position the apparatus 100—in this example, by performing at least a rotation 102—at a pace directed by the apparatus 100, whilst the calibration signals 120A-120C are played back by the loudspeakers 110A-110C, respectively. The user prompts provided by and/or caused to be provided by the apparatus 100 may be visual prompts, audio prompts, tactile prompts via a haptic feedback system, or combinations thereof. In this example, the one-tap calibration process involves acquiring microphone signals and direction data via the apparatus 100, starting from the user 105's frontal look-at direction 102 and continuing until sufficient microphone signals and direction data have been acquired for all of the loudspeakers 110A-110C. Other examples may involve different starting directions. According to this example, the one-tap calibration process involves transmitting and receiving calibration signals that are, or that include, sub-audible DSSS sequences to create a relative map suitable for configuring flexible rendering. Detailed examples of sub-audible DSSS sequences are disclosed herein.

In some examples, the apparatus 100 will prompt the user 105 to point the apparatus 100 for a short period of time at each of the loudspeakers 110A-110C before prompting the user 105 to point the apparatus 100 at the next loudspeaker. The process may proceed in a clockwise direction, a counterclockwise direction or in any arbitrary order.

According to some examples, at some point in the process the apparatus 100 will prompt the user 105 to determine the front of the room or another front/“look at” position. In some implementations this may be done by prompting the user 105 to start with the apparatus 100 pointing at a television, a loudspeaker or another feature of the audio environment 115. Alternatively, the apparatus 100 may prompt the user 105 to indicate the front position by a press of a button—or other user input—when facing the front position. In both examples, the corresponding direction data—such as compass data—will be logged as the front position. In other examples, the front position may be determined by inspecting the device type that a loudspeaker belongs to. For example, if a television has two loudspeakers and is the only television in the audio environment 115 (or includes the only display in the audio environment 115), the front position may be assumed to be a position of the television display. The position of the television display may be a position midway between the two loudspeakers of the television, e.g., a position corresponding with the mid-angle between the two speaker directions, or angles, calculated in the calibration process.

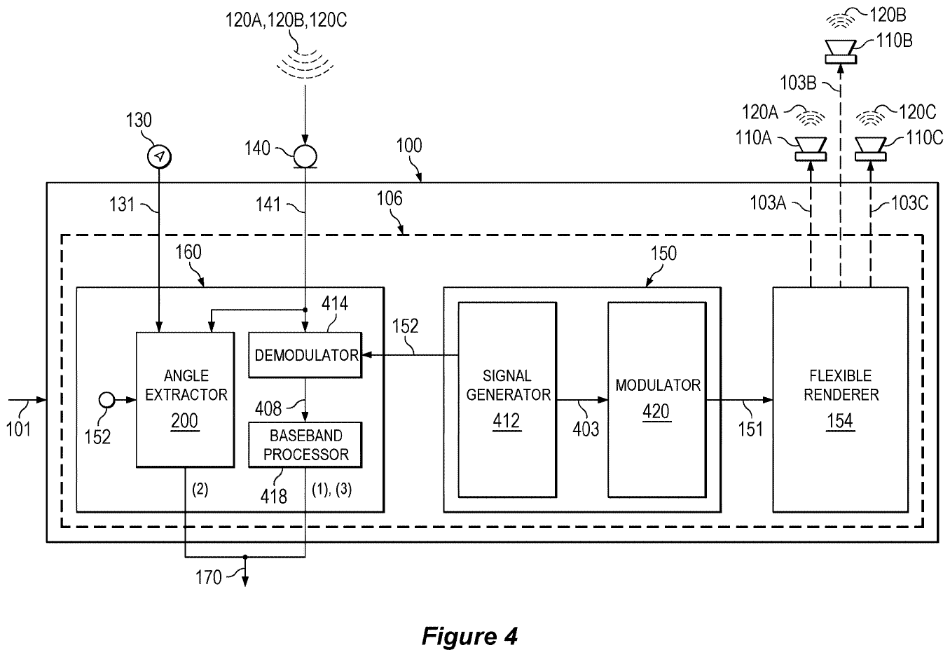

FIG. 4 is a block diagram that shows additional examples of audio device elements according to some disclosed implementations. As with other figures provided herein, the types and numbers of elements shown in FIG. 4 are merely provided by way of example. Other implementations may include more, fewer and/or different types and numbers of elements. In this example, the apparatus 100 of FIG. 4 is an instance of the apparatus 100 that is described above with reference to FIGS. 1A-3.

FIG. 4 shows high-level examples of device components configured for implementing a procedure to derive parameters for determining a map suitable for implementing a flexible rendering process in an audio environment. In this example, FIG. 4 shows the following elements:
131—direction data, including azimuth data;
141—microphone signals;
150—calibration signal generator/modulator, which is configured to generate and modulate DSSS signals in this example;
151—DSSS calibration signal per loudspeaker;
152—DSSS calibration signal parameters per loudspeaker;
154—flexible renderer configured to render audio signals of a content stream such as music, audio data for movies and TV programs, etc., to produce audio playback signals. In this example, the flexible renderer 154 is configured to insert the DSSS calibration signals per loudspeaker 151, which have been received from and modulated by the DSSS signal modulator 420, into the audio playback signals produced by the flexible renderer 154, to generate modified audio playback signals that include the rendered calibration signals 103A-103C for the loudspeakers 110A-110C, respectively. The insertion process may, for example, be a mixing process wherein DSSS signals modulated by the DSSS signal modulator 420 are mixed with the audio playback signals produced by the flexible renderer 154, to generate the modified audio playback signals;
160—data analyzer;
170—results for a current loudspeaker layout;
200—angle extractor configured to estimate direction data (2) corresponding to a direction of each of the loudspeakers 110A-110C relative to the apparatus 100 according to the direction data 131 from the sensor system 130 and microphone signals 141 from the microphone system 140;
412—DSSS signal generator configured to generate the DSSS signals 403 and to provide the DSSS signals 403 to the DSSS signal modulator 420 and the DSSS calibration signal parameters per loudspeaker 152 to the DSSS signal demodulator 414. In this example, the DSSS signal generator 212 includes a DSSS spreading code generator and a DSSS carrier wave generator;
414—DSSS signal demodulator configured to demodulate microphone signals 141. In this example the DSSS signal demodulator 214A outputs the demodulated coherent baseband signals 408. Demodulation of the microphone signals 141 may, for example, be performed using standard correlation techniques including integrate and dump style matched filtering correlator banks. Some detailed examples are described in International Publication No. WO 2022/118072 A1, “Pervasive Acoustic Mapping,” which is hereby incorporated by reference. In order to improve the performance of these demodulation techniques, in some implementations the microphone signals 141 may be filtered before demodulation in order to remove unwanted content/phenomena. According to some implementations, the demodulated coherent baseband signals 408 may be filtered before being provided to the baseband processor 418. The signal-to-noise ratio (SNR) is generally improved as the integration time increases (as the length of the spreading code used increases);
418—baseband processor configured for baseband processing of the demodulated coherent baseband signals 408. In some examples, the baseband processor 418 may be configured to implement techniques such as incoherent averaging in order to improve the SNR by reducing the variance of the squared waveform to produce the delay waveform; and
420—DSSS signal modulator configured to modulate DSSS signals 403 generated by the DSSS signal generator 412, to produce the DSSS calibration signal per loudspeaker 151.

In this example, the calibration signal generator/modulator 150, the flexible renderer 154 and the analyzer 160 are implemented by an instance of the control system 106 of FIG. 1B. According to this example, the DSSS signal generator 412 and the DSSS signal modulator 420 are components of the calibration signal generator/modulator 150. Here, the angle extractor 200, the DSSS signal demodulator 414 and the baseband processor 418 are components of the data analyzer 160.

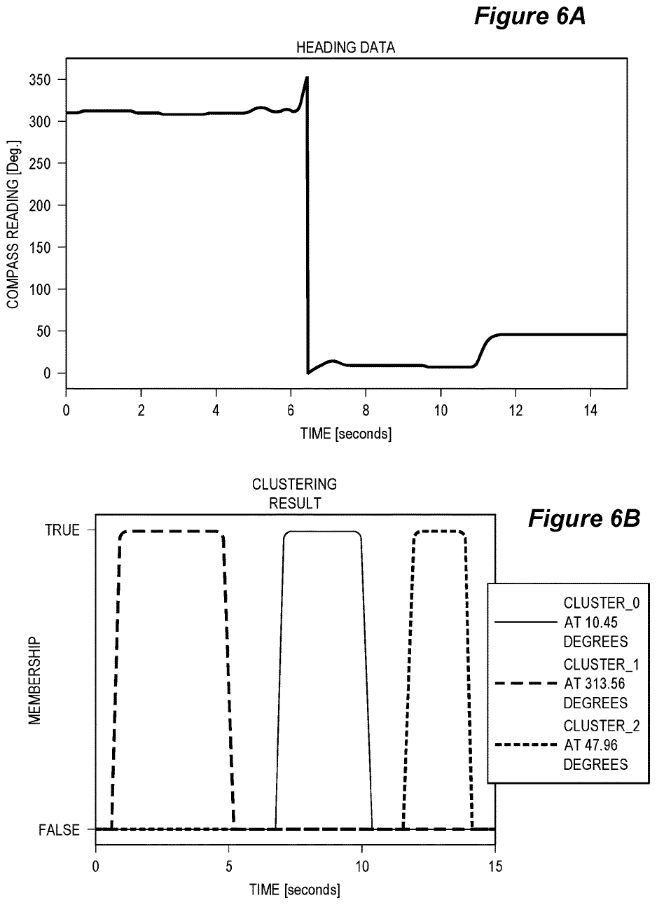

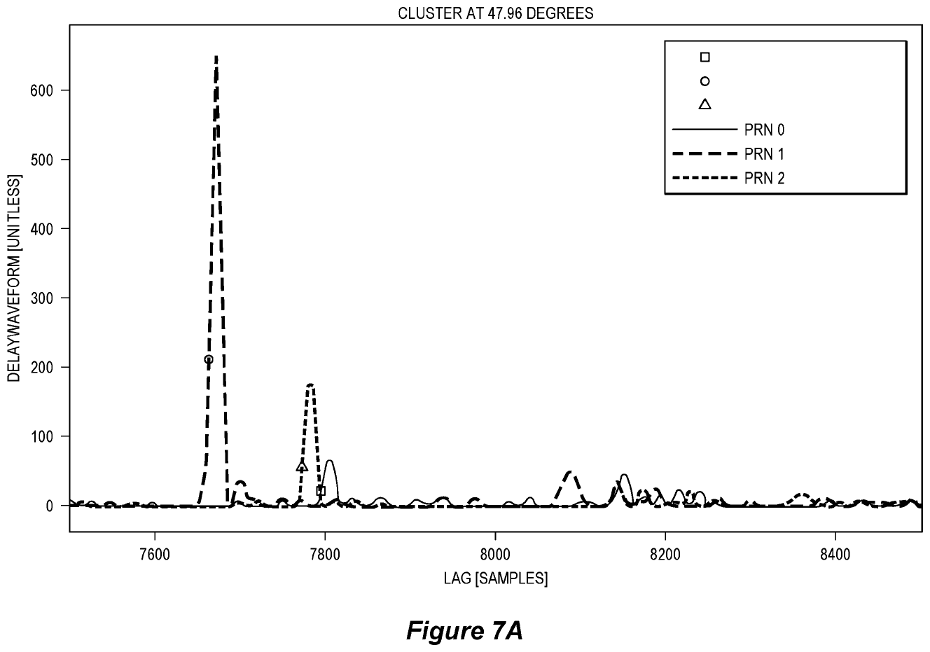

In the example shown in FIG. 4, the DSSS signal generator 414 is configured to generate a code for each of the loudspeakers 110A-110C and carrier signals, which is modulated by the DSSS signal modulator 420 to produce the DSSS calibration signal 151 per loudspeaker and injected into audio playback content (not shown) for flexible rendering by the flexible renderer 154. Each loudspeaker has a different code. In some examples, a TDMA-based, FDMA-based or CDMA-based process may be implemented to improve the robustness of the system. Some relevant methods are disclosed in International Publication No. WO 2022/118072 A1, “Pervasive Acoustic Mapping,” which is hereby incorporated by reference, particularly FIGS. 6, 10 and 11 and the corresponding descriptions, as well as the section entitled “DSSS Spreading Codes.”

Simultaneously, both the sensor system 130 and the microphone system 140 capture data and stream the data to the analyzer 160. According to this example, the azimuth data feed 131 and recording feed 141 are aligned, either during the process of obtaining the data or thereafter.

According to this example, the microphone data 141, which includes microphone signals corresponding to the acoustic DSSS signals played back by each of the loudspeakers 110A-110C, is demodulated by the DSSS signal demodulator 414 and then processed by the baseband processor 418 to produce time of arrival (ToA)-based range data (1) corresponding to a time of arrival of each of the audio calibration signals 120A-120C emitted the loudspeakers 110A-110C, respectively, and received by the sensing device 100, as well as (optionally) the level-based range estimates (3) corresponding to a level of sound produced by each of the loudspeakers 110A-110C. In this example, the baseband processor 418 produces the ToA-based range data (1) and level-based range estimates (3) based on the results of analysis of delay waveforms, such as a leading-edge estimation, an evaluation of the peak level by device code (DSSS calibration signal 151 per loudspeaker), etc.

DSSS signals have previously been deployed in the context of telecommunications. When DSSS signals are used in the context of telecommunications, DSSS signals are used to spread out the transmitted data over a wider frequency range before it is sent over a channel to a receiver. Most or all of the disclosed implementations, by contrast, do not involve using DSSS signals to modify or transmit data. Instead, such disclosed implementations involve sending DSSS signals between audio devices of an audio environment. What happens to the transmitted DSSS signals between transmission and reception is, in itself, the transmitted information. That is one significant difference between how DSSS signals are used in the context of telecommunications and how DSSS signals are used in the disclosed implementations.

Moreover, the disclosed implementations involve sending and receiving acoustic DSSS signals, not sending and receiving electromagnetic DSSS signals. In many disclosed implementations, the acoustic DSSS signals are inserted into a content stream that has been rendered for playback, such that the acoustic DSSS signals are included in played-back audio. According to some such implementations, the acoustic DSSS signals are not audible to humans, so that a person in the audio environment would not perceive the acoustic DSSS signals, but would only detect the played-back audio content.

Another difference between the use of acoustic DSSS signals as disclosed herein and how DSSS signals are used in the context of telecommunications involves what may be referred to herein as the “near/far problem.” In some instances, the acoustic DSSS signals disclosed herein may be transmitted by, and received by, many audio devices in an audio environment. The acoustic DSSS signals may potentially overlaps in time and frequency. Some disclosed implementations rely on how the DSSS spreading codes are generated to separate the acoustic DSSS signals. In some instances, the audio devices may be so close to one another that the signal levels may encroach on the acoustic DSSS signal separation, so it may be difficult to separate the signals. That is one manifestation of the near/far problem, some solutions for which are disclosed herein.

### Deriving the Direction of Loudspeakers

As the user 105 moves the apparatus 100 during a calibration sequence, the direction data 131 is logged. If the user 105 is performing an n+1 tap calibration sequence, the direction data 131 collected near the point in time of the tap is logged and used to estimate the direction of each of the loudspeakers 110A-110C from the position of the apparatus 100, which may be used as a proxy for the user position. In some embodiments, this may be implemented by averaging the data collected within a time interval of the tap, such as within 100-500 ms of the tap. This produces a set of directions corresponding to the user look direction and each loudspeaker. In some examples, the identity of each loudspeaker associated with a user tapping at a speaker direction may need to be estimated. Some examples of loudspeaker identification are described below.

If the user 105 is performing a one-tap calibration process, in some examples the apparatus 100 will prompt the user 105 to rotate the apparatus 100 to point towards each of the loudspeakers 110A-110C and to dwell for some time at each of the loudspeakers 110A-110C—in other words, to continue pointing the apparatus 100 towards each of the loudspeakers 110A-110C—for a time interval. The apparatus 100 may, in some examples, communicate the time interval to the user 105 via one or more prompts, which may be audio prompts, visual prompts, or both. The direction data 131 may, in some examples, be logged continually during the entire calibration sequence. Once the calibration sequence has finished, the directions of each of the loudspeakers 110A-110C may be estimated by the control system 106, for example by the angle extractor 200 shown in FIG. 4.

As the user 105 dwells at the direction of each speaker, the logged direction data will contain clusters centered at the direction. Some examples of estimating the directions of each of the loudspeakers 110A-110C involve employing a clustering algorithm, such as a k-nearest neighbors (kNN) clustering algorithm or a Gaussian Mixture Model (GMM) clustering algorithm. Other examples may exploit the temporal characteristics of the direction data 131 and employ algorithms such as Hidden Markov Models (HMM). In some such examples, the estimated loudspeaker directions may be taken as the centroids of the clusters estimated by a clustering algorithm. In some examples, the timing of the prompts provided to the user may be used to aid in the masking of direction data that was logged during the time the apparatus was rotating—or otherwise being re-positioned—and not dwelling at the loudspeaker direction.

According to some examples, the user may initiate the one-tap calibration process by pointing the apparatus 100 at a look direction, by pointing the apparatus 100 at one of the loudspeakers 110A-110C, or by pointing the apparatus 100 at another direction. If the user 105 does not initiate the process by pointing at a predetermined direction, such as the look direction, in some examples the clustering algorithms will estimate n+1 centroids corresponding to the n speakers and one look direction. In some such examples, the apparatus 100 will prompt the user 105 to point the apparatus 100 at the look direction and to dwell at the look direction.

Some examples of the one-tap calibration process may involve estimating the directions of the loudspeakers 110A-110C during the calibration sequence in real-time. Some such examples may involve adapting the timing of user prompts to rotate/re-position the apparatus 100 to point towards the next loudspeaker in order to ensure sufficient data is collected for estimating loudspeaker directions.

### Acoustic Shadowing

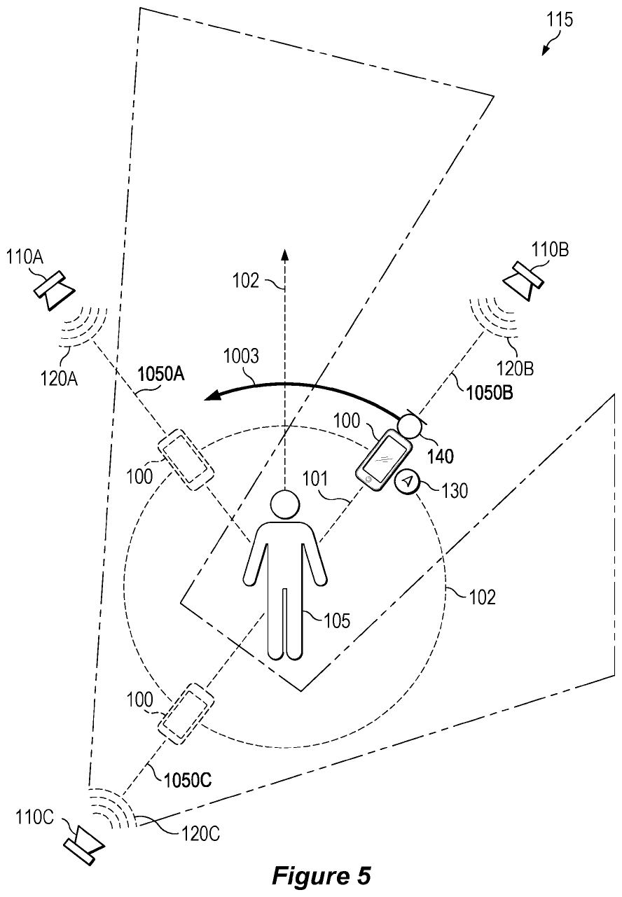

FIG. 5 shows an example of acoustic shadowing. As the user 105 rotates and/or otherwise re-positions the apparatus 100 during a calibration process, the user 105's body will shadow the acoustic calibration signal played back by each loudspeaker for a period of time. This effect is illustrated in FIG. 5, in which the user 1000 is currently shadowing the signal 120C from loudspeaker 110C. With proper selection of the calibration signals and the calibration signals' properties, e.g., the calibration signals' spectral components, acoustic shadowing will result in a drop in the SNR of the processed signal from device 110C. The “signature” caused by acoustic shadowing contains information on the directional location of each loudspeaker in the audio environment 115.

### User Body Models

As the user 105 rotates during the calibration sequence the apparatus 100 will normally translate (move) in the acoustic space as the user 105 rotates about the user 105's center and not about the center of the apparatus 100. This results in the range between the apparatus 100 and the loudspeakers 110A-110C changing during the course of the calibration sequence and being minimum—for a particular loudspeaker—when the apparatus 100 is pointing at that loudspeaker. The change in range causes a signature in the delay estimates made from the demodulated/processed microphone signals 141, which contain information on the directional location of each device in the room and is based on body model factors such as the length of the user 105's arm that is holding the apparatus 100, how far the user 105 extends the arm that is holding the apparatus 100, etc. In some examples, these body model factors may be expressed as known or inferred spatial relationships—such as distances and/or orientations—between the apparatus 100 and at least a portion of the user 105's body, such as the head of the user 105, when the sensor signals and the microphone signals are being obtained during a calibration process. Accordingly, in some examples determining the direction data, the range data, or both, may be based at least in part on one or more known or inferred spatial relationships between the apparatus and the head of the user 105 when the direction data 131 and the microphone signals 141 are being obtained.

### Temporal Masking of Microphone Data

After the directions to the loudspeakers are estimated using the direction data 131, the microphone data 141 may be split into sets. Each set of microphone data 141 may be composed of the microphone data 141 that was collected during the time at which the user 105 was dwelling in the direction of each of the loudspeakers 110A-110C.

In the one-tap process, the dwelling time period may be the time period where the logged direction data is sufficiently close to the estimated directions of the loudspeakers' centroids of the clusters mentioned above. In some examples, “sufficiently close” may be determined by a hard threshold, for example a degree range (such as +/−5 degrees, +/−8 degrees, +/−10 degrees, etc.). In other examples, “sufficiently close” may be determined by a statistical approach, for example within a range of +/−2 standard deviations. A statistical approach may be well-suited to embodiments where a GMM is utilised to estimate the direction of the speakers because, in some such examples, the mean of the clusters may be used as the estimated direction and the variance may be used to determine a time period where the logged direction data are sufficiently close to the estimated direction.

In an n+1 tap process, the temporal mask may be computed as mentioned for the one-tap process. This is true even if a kNN/GMM/HMM clustering algorithm is not used to determine the direction to each of the loudspeakers, because the control system can still apply these algorithms to the data purely to determine the temporal mask.

According to some examples, a temporal mask may be computed for each loudspeaker direction. In some such examples, this temporal mask may be applied to the microphone data so that the analyzer 160 can produce a set of observations for each loudspeaker direction, where each set of observations would contain the demodulated signal of every loudspeaker in the system. In other words, the apparatus 100 may obtain n sets of demodulated signals, one for each period of time the user was dwelling in the direction of each loudspeaker. During this time period, in some examples all loudspeakers may be continually playing their calibration signal and all such calibration signals may be received and demodulated by the apparatus 100.

### Identifying Which Loudspeaker is Located at Each Derived Loudspeaker Direction

In this section, it is an underlying assumption that there is no prior information about the location of the loudspeakers and that all of the loudspeakers are simultaneously playing back audio that includes calibration signals.

After splitting the microphone signal into n sets and demodulating each set with n calibration signals, the control system obtains n² demodulated signals. This example involves exploiting some domain knowledge and make some assumptions about the user 105, in order to identify which loudspeaker is located at each of the directions derived from the direction data 131 according to one of the methods mentioned above. In order to perform this speaker identification, some examples involve formulating an optimization problem, wherein multiple objective cost functions are combined in a weighted manner. In some examples, these objective functions may include time of arrival and/or signal-to-noise ratio (SNR), which due to the acoustic shadowing and/or the effect of the above-mentioned user body model would result in the correct set of loudspeaker identifications, causing the combined objective functions to be minimized. In some examples, this involves:
all possible loudspeaker-to-directions identification combinations being enumerated, then
the objective cost functions being computed for each combination, optionally combining multiple of these in a weighted manner.

The control system may choose the set of speaker-to-direction identifications having the minimal cost to be the solution.

### Example: Gaussian Mixture Model (GMM)-Based Direction Estimation for a One-Tap Calibration Process

FIG. 6A shows examples of raw direction data that was logged during a one-tap calibration process. In this example, the direction data are, or include, compass data.

In some examples, such raw direction data may be clustered, for example using a N=3 component GMM algorithm. According to some such examples, outliers may be detected as samples that are not within M standard deviations of the detected centroids or means. Some examples may involve setting M=[1, 3]. In some examples, the directional data with the outliers removed is then clustered using a N=3 component GMM algorithm. According to some such examples, the centroids (means) of the clusters may then be used as the derived speaker directions.

### Example: Temporally Masked Demodulated Measurements

In some examples, the directional data samples that were not removed at the outlier removal step may then be labelled according to the nearest centroid. In some such examples, a Boolean time series for each centroid index may then be produced which is true whenever the labelled sample is equal to that centroid index. According to some such examples, the time series may then be non-linearly processed using dilation and erosion algorithms, to produce a set of temporal masks.

FIG. 6B shows examples of temporal masks based on clustered directional data. In this example, each cluster is shown with a corresponding estimated loudspeaker direction. According to some examples, the estimated loudspeaker directions may be used to construct temporal masks. As described above, these temporal masks correspond with the time periods at which the apparatus 100 was pointing sufficiently close to one of the loudspeakers. According to some examples, the microphone data 141 may be masked according to the constructed temporal masks.

### Example: Power-Only-Based Speaker-to-Direction Identification

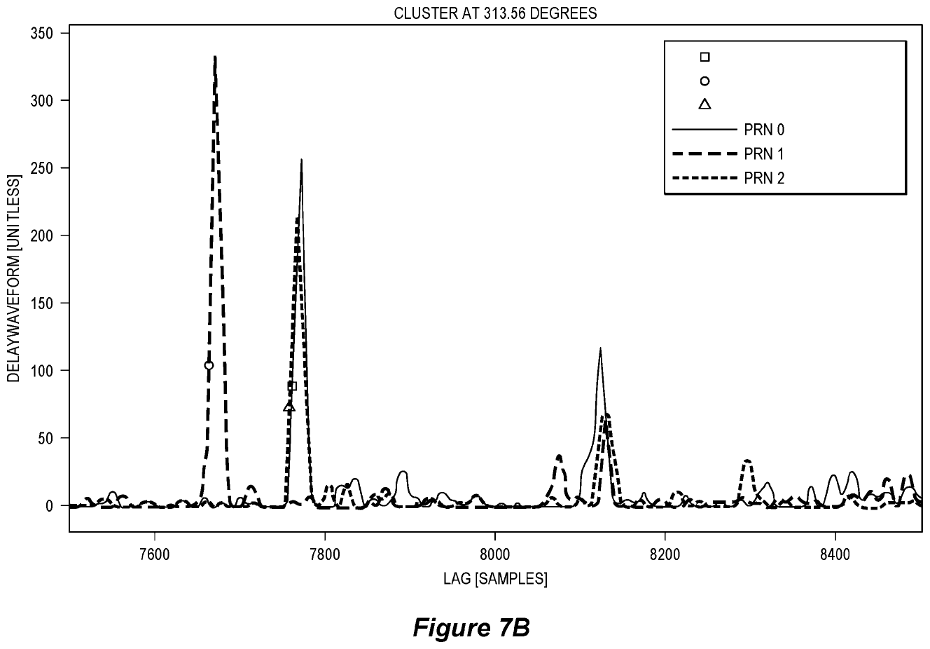

For each of the N directions, N SNR measurements may be made, which can be extracted from a demodulated DSSS signal. Relevant methods are described in International Publication No. WO 2022/118072 A1, “Pervasive Acoustic Mapping,” which is hereby incorporated by reference. An example of these SNR measurements when N=3 are shown in FIGS. 7A-7C. FIGS. 7A, 7B and 7C show demodulated DSSS signals corresponding to the temporal masks shown in FIG. 6B. In these examples, FIG. 7A shows a set of demodulated DSSS signals for a cluster at approximately 48 degrees, FIG. 7B shows a set of demodulated DSSS signals for a cluster at approximately 314 degrees and FIG. 7C shows a set of demodulated DSSS signals for a cluster at approximately 10 degrees.

In order to estimate the loudspeaker at which the apparatus 100 was pointing during each of the time periods (the subplots in FIGS. 7A-7C), some examples formulate the problem as an optimization problem, in this case a maximization problem. One can define an objective cost function based on these measurements as

$${Z}_{SNR} ( Θ ) = {\sum }_{c = 0}^{N - 1} S N R ( {Θ}_{c} , c ) ,$$

where:
SNR (Θ_{c},c) represents a N by N matrix containing the SNR measurements. The row index corresponds to the time mask (direction) and the column index corresponds to the unique calibration code index of the DSSS signal;
Θ_{c} represents the c^{th} hypothesis of all possible enumerated speaker-to-direction hypotheses. It is a vector of length N containing the code(speaker) index. For example, Θ_{c}=[1,2,0] may be interpreted as the hypothesis that speaker 1 is located at direction 0, speaker 2 is located at direction 1 and speaker 0 is located at direction 2;
N represents the number of directions; and
Z_{SNR} represents a power-based objective function.

The control system may compute Z_{SNR} for every possible Θ hypothesis and select the hypothesis with the maximum score as the estimate. One may express this as follows:

$$\hat{Θ} = {arg max}_{i ∈ [ 0 , 1 , N ]} {Z}_{SNR} ( {Θ}^{i} )$$

### Example: Joint Power- and Timing-Based Speaker-to-Direction Identification

In some examples, a timing-based objective cost function may be expressed as follows:

$${Z}_{latency} ( θ ) = \frac{1}{N O} {\sum }_{c = 0}^{N - 1} L ( {Θ}_{C} , c ) , where$$

$$L ( p , c ) = {τ}_{G} + O - TOA ( p , c )$$

In the above equations:
TOA(p,c) represents the time of arrival (TOA) estimate of the p^{th} demodulated DSSS signal which was collected during the temporal mask index c corresponding to the c^{th} direction estimate;
O represents some offset, which may be selected to equal a few meters; and
τ_{G} represents the bulk latency of the system as the loudspeakers are synchronised. We can obtain a rough estimate of this bulk latency by taking the median of all of the TOA(p,c) measurements.

Some examples also involve applying a weighting factor “a,” for example as follows:

$${Z}_{l a t e n c y} ( Θ ) = \frac{1}{N O} {\sum }_{c = 0}^{N - 1} a ( {Θ}_{c} , c ) L ( {Θ}_{c} , c )$$

The weighting factor may, for example, be derived from some signal quality metrics in order to only include good TOA measurements in the cost function. The signal quality metrics may be based on noise power, signal power, the ratio of the two, etc.

The two cost functions may be combined using the following expression:

$${Z}_{joint} ( θ ) = \frac{{Z}_{SNR} ( θ ) + λ {Z}_{l a t e n c y} ( Θ )}{1 + λ} ,$$

where λ≥0 is used to weight the two cost functions. The foregoing expression may be evaluated for Ali permutations of possible loudspeaker-to-apparatus 100 identification vectors and the permutation the maximises this expression may be selected as the estimated speaker-to-device identification vectors:

$$\hat{Θ} = {arg max}_{i ∈ [ 0 , 1 , N ]} {Z}_{joint} ( {Θ}^{i} )$$

The choice of λ may be left to the designer as a static number. In some examples, λ may range from 0 to 10. As λ increases, the weighting of the latency increases over the SNR when identifying loudspeakers. This process may be performed adaptively, for example where the system alters λ according the distribution of the loudspeaker's direction. An example of this would be to increase λ when there are closely spaced speaker-directions. It may also be desirable to make Z_{latency}(Θ) and Z_{SNR}(Θ) on the same range, so performing a soft-max operation or a similar operation on them before combining them may be useful.

### Deriving Absolute Time of Flight

By having some additional information about the loudspeaker layout—such as loudspeaker locations, the types of loudspeakers (for example, whether any are located above a position of the listener, are upward-firing, etc.—an absolute time of flight can be calculated. An estimated absolute time of flight allows a flexible rendering system to change the rendering due to near/far field acoustic effects, distance based psychoacoustic effects, or combinations thereof.

### Deriving Absolute Time of Flight Using Ceiling Height or Another Assumed Dimension

In the case of height loudspeakers, the vertical distance can be assumed based upon the region or location. For example, building codes that apply in Sydney, Australia require that the ceiling height is at least 2.4 m in non-bathrooms. Since buildings are built to a cost most buildings can be assumed to have a height of 2.4 m in non-bathrooms. If the listener location is assumed to be 45 cm off the ground—the standard height of a chair—the height speaker can be assumed to be 1.9 m above the listener. Using a gravity sensor, a gyroscope, etc., in a sensing device containing the microphones, the angle of the user to the height speaker can be calculated and then the simple equation below can be used to calculate the time of flight to the height speaker in absolute terms.

$$distance to the user = \frac{height above listener}{sin ( elevation\_angle \_to \_speaker )}$$

$$time of flight = \frac{distance to user}{speed of sound in air at 20 degrees Celsius}$$

Once the time of flight is known for one loudspeaker it can be calculated for the rest of the loudspeakers if the times of arrival of audio calibration signals emitted by all the other loudspeakers have been calculated, for example by the methods described elsewhere in this document.

### Deriving Absolute Time of Flight Using a Second Set of Measurements

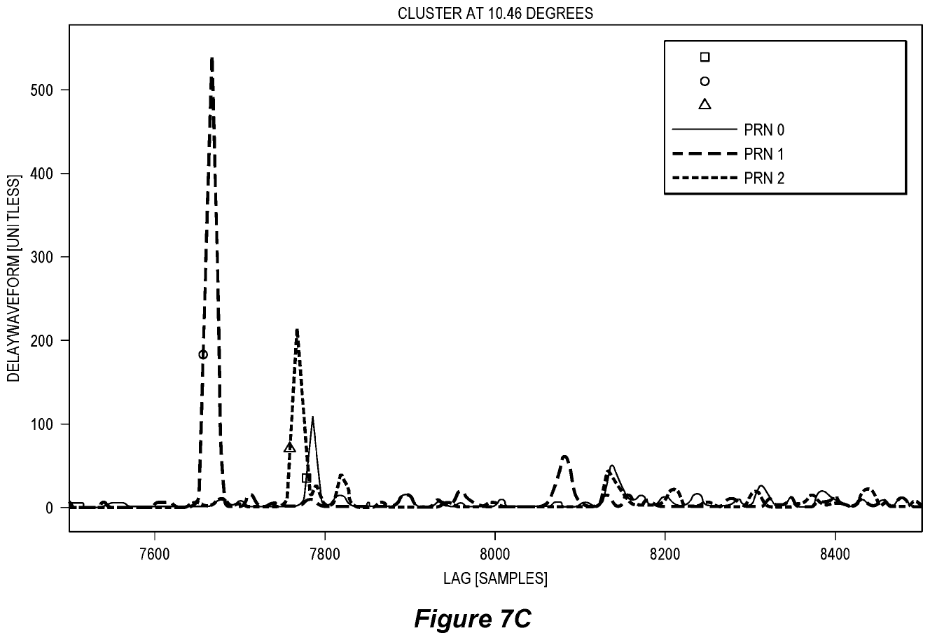

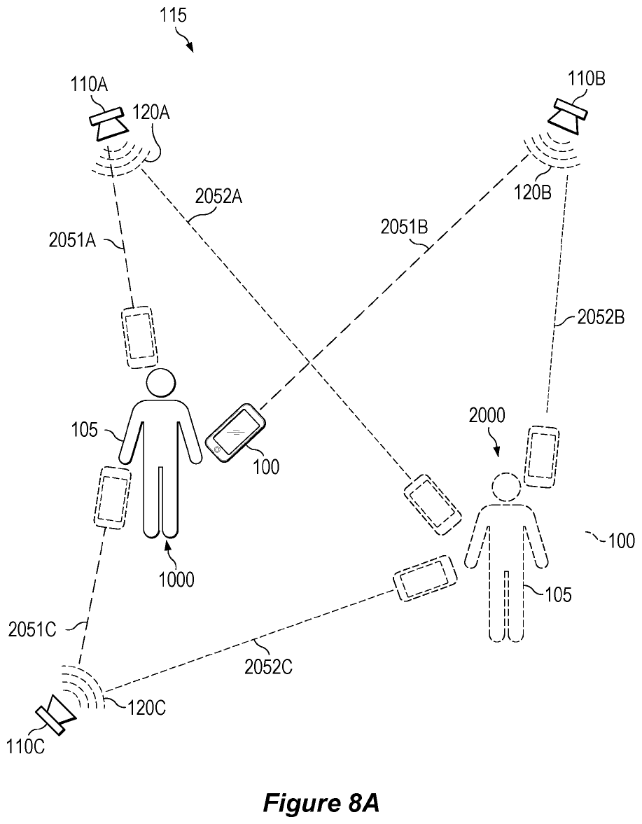

FIG. 8A shows a listener in two different positions within an audio environment. In this example, at each of these two positions the user 105 positions the apparatus 100 in various orientations to obtain calibration measurements like those described elsewhere herein.

FIG. 8A includes the following elements:
1000—A first position of the user 105;
2000—A second position of the user 105;
2051A, 2051B and 2051C—ranges from user position 1000 to loudspeakers 110A, 110B and 110C, respectively;
2021A, 2052B and 2052C—ranges from user position 2000 to loudspeakers 110A, 110B and 110C, respectively.

Let S1=loudspeaker 110A, S2=loudspeaker 1101B and S3=loudspeaker 110C in this section.

If two or more sets of observations made at different positions in the audio environment 115, then the absolute times of flight, room scale and clock difference between the playback system and the apparatus 100 can be resolved. This is because the number of observations Nₒ is greater than the number of unknowns Nᵤ.

$${N}_{o} = 2 {N}_{s} {N}_{p}$$

Where Nₛ is the number of speakers and Nₚ is the number of user positions where a set of observations has been taken. In FIG. 8A, Nₛ=3 and Nₚ=2. In this example, for each set of observations, the user 105 obtains ToA and DoA observations from each loudspeaker. The number of unknowns is:

$${N}_{u} = 2 {N}_{s} + 2 {N}_{p} + 1$$

This example involves estimating the position x and y of each loudspeaker and each user position along with the singular clock offset value between the loudspeakers and the apparatus 100. As a result, for Nₛ>2, we need at least 2 sets of observations/2 different user positions, and for Nₛ==2 we need at least 3 sets of observations/3 different user positions. It is possible to solve for a different clock offset at each user position, if the number of observables permit it. However, during the calibration process, it is not difficult to ensure that the clock offset between observations taken at different user positions is zero and doing so reduces the number of variables and improves the performance of the system.

The measured range, 2051A, between device i and user position j may be expressed as:

$${p}_{ji} = \sqrt{{( {U}_{j , x} - {S}_{i , x} )}^{2} + {( {U}_{j , y} - {S}_{i , y} )}^{2}} + bC ,$$

where:
U_{j,x} represents the x component of user j's position;
U_{j,y} represents the y component of user j's position;
S_{i,x} represents the x component of speaker i's position;
S_{i,y} represents the y component of speaker i's position;
b represents the clock offset in seconds; and
C represents the speed of sound.

The measured range may be obtained by taking the measured time of arrival and multiplying it by the speed of sound.

The measured angle of arrival, between speaker i and user position j can be expressed as a unit vector:

$${d}_{ji} = \frac{( {U}_{j , x} - {S}_{i , x} , {U}_{j , y} - {S}_{i , y} )}{\sqrt{{( {U}_{j , x} - {S}_{i , x} )}^{2} + {( {U}_{j , y} - {S}_{i , y} )}^{2}}}$$

We can solve for all the unknowns in a state vector, X,

$$X = {[ {S}_{1 , x} , {S}_{1 , y} , {S}_{2 , x ,} {S}_{2 , y} ... . {S}_{{N}_{s} x} , {S}_{{N}_{s} y ,} {U}_{2 , x ,} {U}_{2 , y} ... . {U}_{{N}_{p} x} , {U}_{{N}_{p} y} , b ]}^{T}$$

Using an observation vector

$$O = \text{} {[ {p}_{11} , {p}_{12} , ... {d}_{11 , x} , {d}_{11 , y} {d}_{12 , x} , {d}_{12 , y} , {p}_{21} , \\ {p}_{22} , ... {d}_{21 , x} , {d}_{21 , y} {d}_{22 , x} , {d}_{22 , y} , ... . ]}^{T}$$

and taking a linearized least-squares approach using

$$Δ o = A Δ x , where$$

$$Δ o = O - \hat{O} represents the residual between the actual and estimated observation vector ;$$

O represents the actual measured observation vector;
Ô represents an observation vector created from the estimated state vector X;
Δx represents the update to be applied to our current state vector estimate X; and
A represents the linearised observation matrix.

A may be expressed as follows:

,where

$$\frac{δ {p}_{ji}}{δ {S}_{i , x}} = \frac{- ( {U}_{j , x} - {S}_{i , x} )}{{r}_{ji}}$$

$$\frac{{dp}_{ji}}{{dS}_{i , y}} = \frac{- ( {U}_{j , y} - {S}_{i , y} )}{{r}_{ji}}$$

$$\frac{δ {p}_{ji}}{δ {U}_{j , x}} = - \frac{δ {p}_{ji}}{δ {S}_{i , x}}$$

$$\frac{δ {p}_{ji}}{δ {U}_{j , y}} = - \frac{δ {p}_{ji}}{δ {S}_{i , y}}$$

$$\frac{δ {d}_{ji , x}}{δ {S}_{i , x}} = \frac{{( {U}_{j , y} - {S}_{i , y} )}^{2}}{{{r}_{ji}}^{3}}$$

$$\frac{δ {d}_{ji , x}}{δ {S}_{i , y}} = \frac{- ( {S}_{i , x} - {U}_{j , x} ) ( {S}_{i , y} - {U}_{j , y} )}{{{r}_{ji}}^{3}}$$

$$\frac{δ {d}_{ji , y}}{δ {S}_{i , x}} = \frac{- ( {S}_{i , x} - {U}_{j , x} ) ( {S}_{i , y} - {U}_{j , y} )}{{{r}_{ji}}^{3}}$$

$$\frac{δ {d}_{ji , y}}{δ {S}_{i , y}} = \frac{{( {U}_{j , x} - {S}_{i , x} )}^{2}}{{{r}_{ji}}^{3}}$$

$$\frac{δ {d}_{ji , x}}{δ {U}_{i , x}} = - \frac{δ {d}_{ji , x}}{δ {S}_{i , x}}$$

$$\frac{δ {d}_{ji , x}}{δ {U}_{i , y}} = - \frac{δ {d}_{ji , x}}{δ {S}_{i , y}}$$

$$\frac{δ {d}_{ji , y}}{δ {U}_{i , x}} = - \frac{δ {d}_{ji , y}}{δ {S}_{i , x}}$$

$$\frac{δ {d}_{ji , y}}{δ {U}_{i , y}} = - \frac{δ {d}_{ji , y}}{δ {S}_{i , y}}$$

$$\frac{{dp}_{ji}}{db} = 1$$

$$\frac{{dd}_{ji}}{db} = 0$$

$${r}_{ji} = \sqrt{{( {U}_{j , x} - {S}_{i , x} )}^{2} + {( {U}_{j , y} - {S}_{i , y} )}^{2}}$$

Note that user position 1 (shown as position 1000 in FIG. 8A) is omitted from the state vector and is set to 0,0 arbitrarily, which defines the origin of the solution. In this example, the estimated loudspeaker and user positions are initialized using the raw ToA and DoA observations, while the clock estimate b is initialized to be zero. These initial values compose the state vector X. The estimates in X are used to compute the estimated observation vector Ô which is then subtracted from the actual observation vector to produce Δo. The state vector update may be computed as follows:

$$Δ x = pinv ( A ) Δ o ,$$

where pinv( ) represent the pseudo inverse function. The state vector can be updated by

$$X = X + Δ x ,$$

and the process can be repeated until convergence. Convergence is typically detected when the magnitude of Δx is sufficiently small, where “sufficiently small” may be within a predetermined range.

More advanced variants consider second-order effects that improve the performance of the method.

### Deriving Absolute Time of Flight Using Enclosure Size

In some implementations, there will be loudspeaker enclosures that have multiple rendering channels or loudspeakers within an enclosure. Some examples include stereo televisions and soundbars. In some such loudspeaker enclosures there may be a significant distance between the different rendering channels. The distance between loudspeakers is known at manufacturing time because it is an intrinsic property of the device.

Because these rendering channels are independently addressable, some implementations involve measure the relative delay of each rendering channel by prompting the user 105 to point to each rendering channel using the apparatus 100 during the measurement of the time delay and angle. In the example of a television, if the loudspeakers are hidden, the television may display a visual cue to indicate the location of each loudspeaker. After all the time delays are measured and combined with the angle data, the measured time of arrival can be converted to time of flight data.

In this particular case, if we consider just two loudspeakers in the enclosure, then, to resolve the scale on the xy plane and derive absolute time of flight using the enclosure size we need to solve for [S_{1,x}, S_{1,y}, S_{2,x}, S_{2,y}, b]. We have knowledge of q₁₂ which is the distance between the loudspeaker 1 and loudspeaker 2 within the enclosure and we also have a measured range and angle of arrival for each of the two enclosures. Thus, we have 5 unknowns and 5 observations and can solve for the unknowns as we have sufficient information. In general, if we have Nₛ loudspeakers, then there are

$${N}_{u} = 2 {N}_{s} + 1$$

unknowns as we can arbitrarily define the user position as the origin without losing any generality of our solution. The first term on the right hand side is due to solving for the x,y position of the loudspeaker, while the additional 1 is the clock bias between the apparatus and playback system. Further, we have

$${N}_{o} = 2 {N}_{s} + \frac{{( {N}_{s} - 1 )}^{2} + {N}_{s} - 1}{2}$$

observables. The first term on the right hand side is due to the measured range and angle of arrival of each loudspeaker while the second term is due to the a priori knowledge of the distance between each loudspeaker within the enclosure. For any Nₛ≥2, we have sufficient observables to solve for the unknowns in the system.

The known distance between the i^{th} and j^{th} loudspeakers in the enclosure may be expressed as follows:

$${q}_{ji} = \sqrt{{( {S}_{j , x} - {S}_{i , x} )}^{2} + {( {S}_{j , y} - {S}_{i , y} )}^{2}}$$

The measured range, 2051A, between loudspeaker i and the user position may be expressed as:

$${p}_{ji} = \sqrt{{( {U}_{x} - {S}_{i , x} )}^{2} + {( {U}_{y} - {S}_{i , y} )}^{2}} + b C$$

The measured angle of arrival between loudspeaker i and the user position can be expressed as a unit vector:

$${d}_{ji} = \frac{( {U}_{x} - {S}_{i , x} , {U}_{y} - {S}_{i , y} )}{\sqrt{{( {U}_{x} - {S}_{i , x} )}^{2} + {( {U}_{y} - {S}_{i , y} )}^{2}}}$$

Similar to what was done in the “Deriving Absolute Time of Flight Using a Second Set of Measurements” section, we can construct a least squares solution to this by defining our state vector, X, as

$$X = {[ {S}_{1 , x} , {S}_{1 , y} , {S}_{2 , x} , {S}_{2 , y} ... . {S}_{{N}_{S} , x} , {S}_{{N}_{S} , y} , b ]}^{T} ,$$

by defining our observation vector as

$$O = {[ {p}_{1} , {p}_{2} , ... , {p}_{{N}_{S}} {d}_{1 , x} , {d}_{1 , y} {d}_{2 , x} , {d}_{2 , y} , {d}_{{N}_{S} , x} , {d}_{{N}_{s} , y} , ... {q}_{11} , ... , {q}_{{N}_{S} ( {N}_{S} - 1 )} , ]}^{T}$$

and by taking a linearized least-squares approach similar to what is described in the Deriving Absolute Time of Flight Using a Second Set of Measurements” section. In order to construct this matrix, we can define

$$\frac{{dq}_{ji}}{{dS}_{i , y}} = \frac{- ( {S}_{j , y} - {S}_{i , y} )}{{q}_{ji}}$$

in view of the fact that we have introduced a new observable into the vector O. After solving iteratively for X, we can obtain the clock estimate b, which can then be used to convert the measured time of arrival and pseudoranges into time of flights and ranges, respectively. Furthermore, the solution contains the positions of the loudspeakers from which the absolute time of flight can be computed. The user position was arbitrarily and without loss of generality chosen to be the origin of the frame the solution was computed in this example. However, other origins may be selected. For example, any of the loudspeaker positions could have been chosen as the origin, and in such cases the loudspeaker position at the origin would be omitted from the state vector X and the user position would be added to the state vector X.

In some examples, the user position is assumed to be aligned with the center of a television (TV). In such examples, an analytical solution can be formulated using the law of sines and the fact that an internal triangle set of angles adds to 180 degrees. For example, if the loudspeaker enclosure is a stereo device and the distances between the user and the two render channels/loudspeakers makes a triangle “xyz,” solving the following equations will yield the orientation of the device and the absolute time of flight to the user:

$$\frac{x}{sin ( alpha )} = \frac{y}{sin ( beta )} = \frac{z}{sin ( theta )}$$

$$alpha + beta + theta = 180 degrees$$

$$time of flight = \frac{distance}{speed of sound in air at 20 degrees Celsius}$$

$$y = z + ( distance between render channel 1 and render channel 2 ) ,$$

$$where \begin{matrix}x = distance between render channels within enclosure ; \\ y = distance from the user to render channel 1 ; \\ z = distance from the user to render channel 2 ;\end{matrix}$$

alpha=angle between render channel 1 and 2 measured by orientation based
sensor described elsewhere in this document;
beta=the angle opposite the distance “y” making up the triangle xyz; and
theta=the angle opposite the distance “z” making up the triangle xyz.

In this particular case, where the user is predetermined to be in the center of the TV enclosure, then

$$beta = theta = ( 180 - alpha ) / 2$$

Moreover, y and z are also equal and we can then solve for these using the law of sines.

The absolute times of flight for this one enclosure can then be used to convert all the other relative time delays to absolute times of flight from the other loudspeakers to the listener. The absolute times of flight can then be used to configure the flexible renderer with an enhanced map that takes into account near/far effects, psychoacoustic effects based upon distance, etc. The orientation derived can also be used to enhance the rendering process.

### Example: (n+1)-Tap Calibration Process

FIG. 8B shows an alternative calibration process that requires multiple user inputs to generate a map. This calibration process requires the user 105 to “tap once”—or otherwise provide input 101 to the apparatus 100 in order to initiate the calibration. The apparatus 100 then prompts the user 105, and/or causes prompts to be made to the user 105, to point the apparatus 100 to each of the loudspeakers 110A-110C. In some such examples, the apparatus 100 causes the loudspeakers 110A-110C to provide a sequence of audio prompts to the user 105 during a calibration process. For example, the apparatus 100 may cause each of the loudspeakers 110A-110C to provide one or more audio prompts, in sequence, to point the apparatus 100 to a corresponding one of the loudspeakers during the calibration process.

According to some examples, the apparatus 100 itself may provide one or more audio prompts, visual prompts, or combinations thereof during the calibration process. In some examples, the apparatus 100 will prompt a user to obtain calibration data from the loudspeakers 110A-110C in a sequence that is based on the device ordering of a flexible renderer, which in some examples may be implemented by the apparatus 100.

In this example, the calibration process starts with the user 105 pointing the apparatus 100 at a front or “look-at” direction, which is labelled “102-start” in FIG. 8B. Then, initiating the calibration via input (101) will cause the apparatus 100 to log the current direction as the reference front or “look-at” direction and will cause the apparatus 100 to commence playback of calibration signals 120A-120C. According to this example, the loudspeaker 110A will then use an audible cue, such as a voice overlay (for example, “point your device at me”), a visible cue (such as flashing LED) or a combination of both to draw the user 105's attention and to prompt the user 105 to point the apparatus 100 at the loudspeaker 110A and thus log the direction of loudspeaker 110A responsive to user input 101A. This process repeats for all of the other loudspeakers in the layout. In the example shown in FIG. 8B, the user 105's movements will follow the arc (102-start→102-A→102-B→102-C). This will result in a total of (n+1) user inputs to the apparatus 100, hence the name “(n+1)-tap calibration process.”

Various implementations of signal chain for delay and level estimation are possible for (n+1)-tap calibration processes. The following sections provide several non-limiting examples.

### Sub-Audible DSSS Signals Masked by Playback Content

As in the one-tap calibration process described earlier in this document, sub-audible DSSS signals masked by playback content can be used as the calibration signals for (n+1)-tap calibration processes.

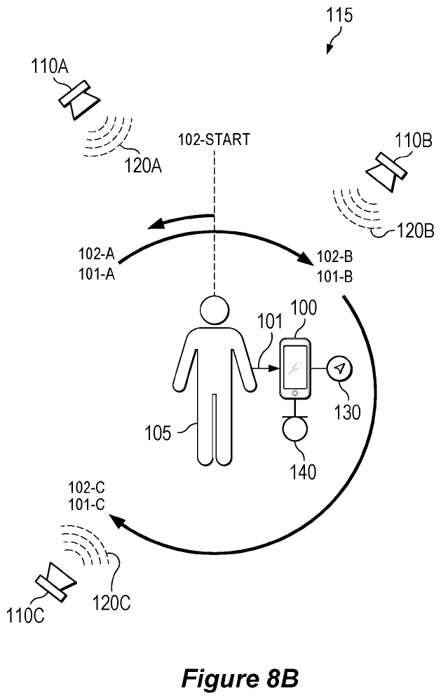

FIG. 9 shows a block diagram of a signal chain for an (n+1)-tap calibration process according to one example. In this example, FIG. 9 is very similar the same as FIG. 4. One difference between FIG. 9 and FIG. 4 is that in the example shown in FIG. 9, device direction estimation occurs independently from DSSS analysis of microphone data 141 by the DSSS demodulator 414 and the baseband processor 418. This is because in the example shown in FIG. 9, loudspeaker direction estimation is made directly from the azimuth—and in some examples, altitude—direction data 131 that is captured during the process described with reference to FIG. 8B, in which the user 105 provides user input 101 for the angle logger 300 to log the angle after pointing the apparatus 100 towards each of the loudspeakers 110A-110C.

The logged angles will be received in the order that the user was directed to log them. In this example, the use of DSSS-based calibration signals allows the time delays for each loudspeaker to be matched with the logged angles, because the delay measurements have an implicit code that indicates which loudspeaker has played which signal.

General Uncorrelated Signals as Calibration Signals with Simultaneous Playback

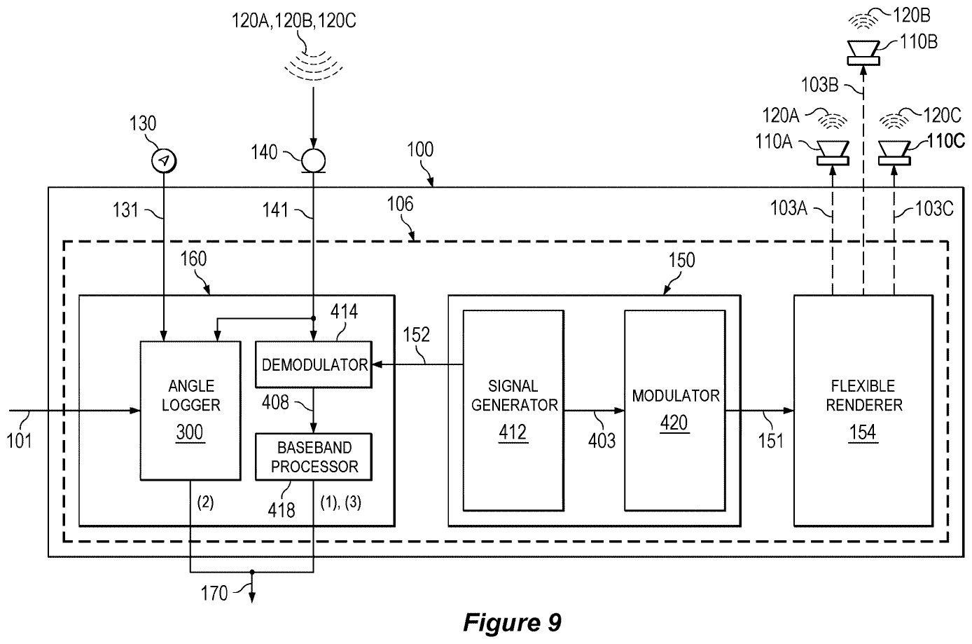

FIG. 10 shows example blocks of an alternative signal processing chain. A processing chain such as that shown in FIG. 10 may be used for processing calibration signals other than DSSS signals that can be masked by playback content. In some such examples, the calibration signal generator 150 may be configured to generate n uncorrelated variants of the calibration signal that may be used to implement an n+1-tap calibration process. Examples of such calibration signals include but are not limited to pink noise.

FIG. 10 shows the following elements:

$$\begin{matrix}301 - cross - correlator \\ 302 - peak finder \\ 310 - cross correlation against original calibration signal per speaker\end{matrix}$$

In the example shown in FIG. 10, the calibration signal generator 150 is configured to generate n uncorrelated variants of the calibration signal, one variant for each of the loudspeakers 110A-110C. Simultaneously, each of the loudspeakers 110A-110C plays back one variant of the calibration signal, which is recorded by the microphone system 140.

According to the example shown in FIG. 10, the cross-correlator 301 is configured to cross-correlate the microphone signals 141 against the original calibration signal per loudspeaker 151 to obtain the cross correlation 310, which is analysed by the peak finder to search for the peak signal level. In this example, the delay of the peak for each loudspeaker corresponds to the time delay estimate for the ToA-based range data (1), whereas the level of the peak-after normalization and noise removal-corresponds to the level estimate for the level-based range estimates (3).

In this example, the procedure for angle estimation is the same as that described with reference to FIGS. 8B and 9.

General Signals as Calibration Signals with Sequential Playback

It is possible to further generalize the implementation of the delay and level estimation to use any calibration signal, if calibration signal playback is made to be not simultaneous, and instead sequential. Some such implementations may be the same as that described with reference to FIGS. 8B-10, except that the calibration signal may, for example, be the same calibration signal playing from each of the loudspeakers 110A-110C, one after another. The same cross-correlation analysis 301 and peak finding analysis 302 as discussed with reference to FIG. 10 may be performed between the recording of the sequentially played-back calibration signal 120 mixed with playback content and the original calibration signal 151.

According to some examples, playback of the calibration signal one loudspeaker at a time may occur in response to user input. For example, after the user 105 logs input to the system for angle measurement of the loudspeaker 110A—responsive to prompts from the apparatus 100 and/or the loudspeaker 110A—the loudspeaker 110A may play back the calibration signal. The same process may be followed until calibration data for all loudspeakers have been obtained. Alternatively, the sequential playback may happen at a pre-programmed pace. The procedure for angle estimation may be the same as that described with reference to FIGS. 8B-10.

### Details Regarding DSSS Signals

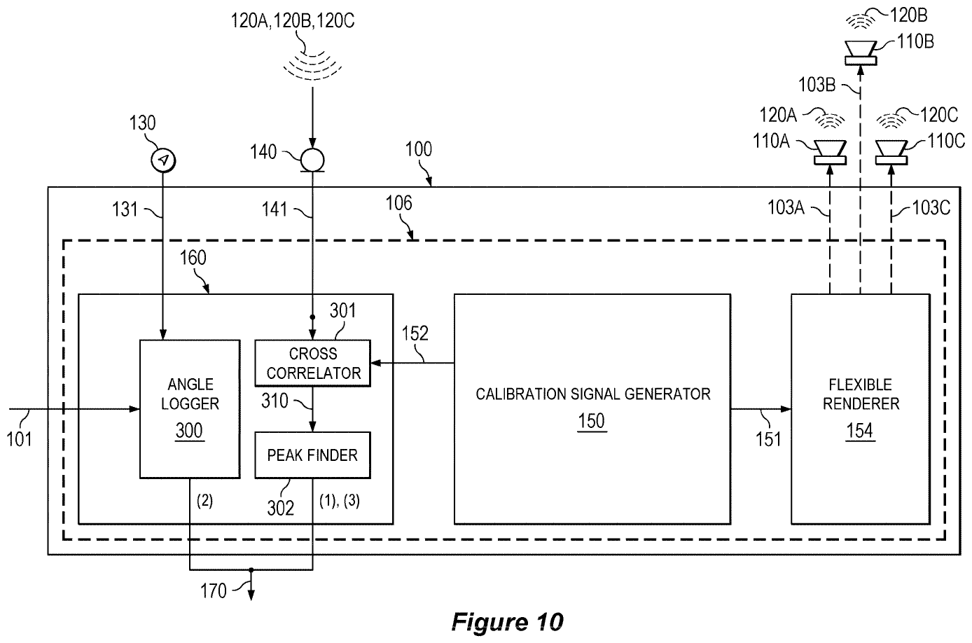

FIG. 11 is a graph that shows examples of the levels of a content stream component of the audio device playback sound and of a DSSS signal component of the audio device playback sound over a range of frequencies. In this example, the curve 1101 corresponds to levels of the content stream component and the curve 1130 corresponds to levels of the DSSS signal component.

A DSSS signal typically includes data, a carrier signal and a spreading code. If we omit the need to transmit data over a channel, then we can express the modulated signal s(t) as follows:

$$s ( t ) = A C ( t ) sin ( 2 π {f}_{0} t )$$

In the foregoing equation, A represents the amplitude of the DSSS signal, C(t) represents the spreading code, and Sin(represents a sinusoidal carrier wave at a carrier wave frequency of f₀ Hz. The curve 1130 in FIG. 11 corresponds to an example of s(t) in the equation above.

One of the potential advantages of some disclosed implementations involving acoustic DSSS signals is that by spreading the signal one can reduce the perceivability of the DSSS signal component of audio device playback sound, because the amplitude of the DSSS signal component is reduced for a given amount of energy in the acoustic DSSS signal.

This allows us to place the DSSS signal component of audio device playback sound (e.g., as represented by the curve 1130 of FIG. 11) at a level sufficiently below the levels of the content stream component of the audio device playback sound (e.g., as represented by the curve 1101 of FIG. 11) such that the DSSS signal component is not perceivable to a listener. Some disclosed implementations exploit the masking properties of the human auditory system to optimize the parameters of the DSSS signal in a way that maximises the signal-to-noise ratio (SNR) of the derived DSSS signal observations and/or reduces the probability of perception of the DSSS signal component. Some disclosed examples involve applying a weight to the levels of the content stream component and/or applying a weight to the levels of the DSSS signal component. Some such examples apply noise compensation methods, wherein the acoustic DSSS signal component is treated as the signal and the content stream component is treated as noise. Some such examples involve applying one or more weights according to (e.g., proportionally to) a play/listen objective metric.

### DSSS Spreading Codes

As noted elsewhere herein, in some examples calibration signals may be, or may include, one or more DSSS signals based on DSSS spreading codes. The spreading codes used to spread the carrier wave in order to create the DSSS signal(s) are extremely important. The set of DSSS spreading codes is preferably selected so that the corresponding DSSS signals have the following properties:
1. A sharp main lobe in the autocorrelation waveform;
2. Low sidelobes at non-zero delays in the autocorrelation waveform;
3. Low cross-correlation between any two spreading codes within the set of spreading codes to be used if multiple devices are to access the medium simultaneously (e.g., to simultaneously play back modified audio playback signals that include a DSSS signal component); and
4. The DSSS signals are unbiased, (have zero DC component).

The family of spreading codes (e.g., Gold codes, which are commonly used in the GPS context) typically characterizes the above four points. If multiple audio devices are all playing back modified audio playback signals that include a DSSS signal component simultaneously and each audio device uses a different spreading code (with good cross-correlation properties, e.g., low cross-correlation), then a receiving audio device should be able to receive and process all of the acoustic DSSS signals simultaneously by using a code domain multiple access (CDMA) method. By using a CDMA method, multiple audio devices can send acoustic DSSS signals simultaneously, in some instances using a single frequency band. Spreading codes may be generated during run time and/or generated in advance and stored in a memory, e.g., in a data structure such as a lookup table.

To implement DSSS, in some examples binary phase shift keying (BPSK) modulation may be utilized. Furthermore, DSSS spreading codes may, in some examples, be placed in quadrature with one another (interplexed) to implement a quadrature phase shift keying (QPSK) system, e.g., as follows:

$$s ( t ) = {A}_{I} {C}_{I} ( t ) cos ( 2 π {f}_{0} t ) + {A}_{Q} {C}_{Q} ( t ) sin ( 2 π {f}_{0} t )$$

In the foregoing equation, A_{I} and A_{Q} represent the amplitudes of the in-phase and quadrature signals, respectively, C_{I} and C_{Q} represent the code sequences of the in-phase and quadrature signals, respectively, and f₀ represents the centre frequency of the DSSS signal. The foregoing are examples of coefficients which parameterise the DSSS carrier and DSSS spreading codes according to some examples. These parameters are examples of the DSSS information 205 that is described above. As noted above, the DSSS information 205 may be provided by an orchestrating device, such as the orchestrating module 213A, and may be used, e.g., by the signal generator block 212 to generate DSSS signals.

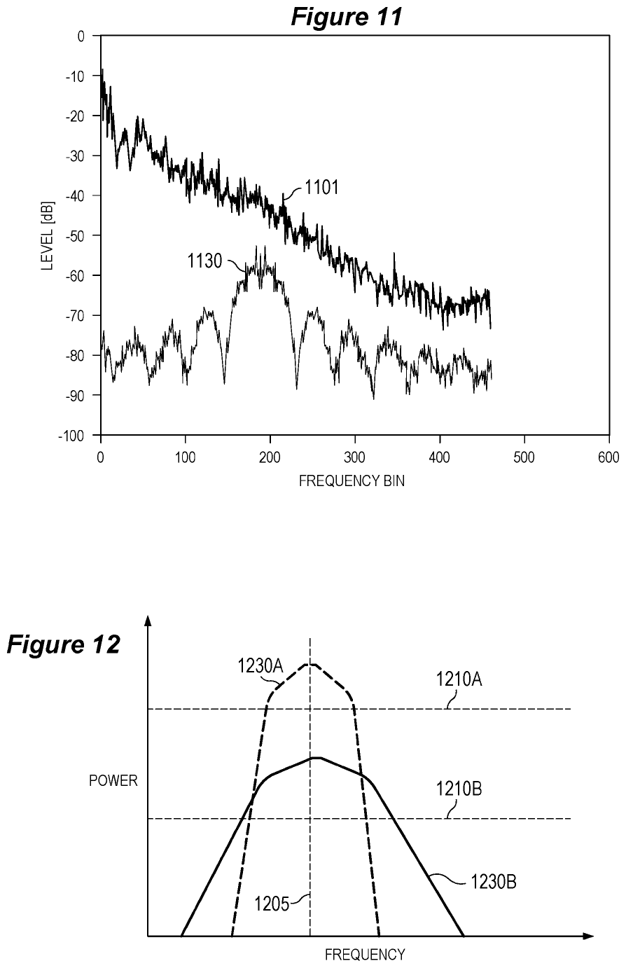

FIG. 12 is a graph that shows examples of the powers of two DSSS signals with different bandwidths but located at the same central frequency. In these examples, FIG. 12 shows the spectra of two DSSS signals 1230A and 1230B that are both centered on the same center frequency 1205. In some examples, the DSSS signal 1230A may be produced by one audio device of an audio environment (e.g., by the audio device 100A) and the DSSS signal 1230B may be produced by another audio device of the audio environment (e.g., by the audio device 100B).

According to this example, the DSSS signal 1230B is chipped at a higher rate (in other words, a greater number of bits per second are used in the spreading signal) than the DSSS signal 1230A, resulting in the bandwidth 1210B of the DSSS signal 1230B being larger than the bandwidth 1210A of the DSSS signal 1230A. For a given amount of energy for each DSSS signal, the larger bandwidth of the DSSS signal 1230B results in the amplitude and perceivability of the DSSS signal 1230B being relatively lower than those of the DSSS signal 1230A. A higher-bandwidth DSSS signal also results in higher delay-resolution of the baseband data products, leading to higher-resolution estimates of acoustic scene metrics that are based on the DSSS signal (such as time of flight estimates, a time of arrival (ToA) estimates, range estimates, direction of arrival (DoA) estimates, etc.). However, a higher-bandwidth DSSS signal also increases the noise-bandwidth of the receiver, thereby reducing the SNR of the extracted acoustic scene metrics. Moreover, if the bandwidth of a DSSS signal is too large, coherence and fading issues associated with the DSSS signal may become present.

The length of the spreading code used to generate a DSSS signal limits the amount of cross-correlation rejection. For example, a 10 bit Gold code has just −26 dB rejection of an adjacent code. This may give rise to an instance of the above-described near/far problem, in which a relatively low-amplitude signal may be obscured by the cross correlation noise of another louder signal. Some of the novelty of the systems and methods described in this disclosure involves orchestration schemes that are designed to mitigate or avoid such problems.

Tracking User Location Using Audio Calibration Signal Bursts Triggered by the User's Interactions with a Remote Control Device

After the calibration process has been completed, estimates of the loudspeaker positions are available for subsequent estimation of the user position using the measured delay between the loudspeakers and a remote control. The rendering process can be calibrated for this user position without the need to repeat an explicit calibration process. The user position can be tracked over time using the position of the remote control as a proxy for the position of the user. When the user interacts with the remote control, in some examples the control system causes each of the loudspeakers to play a burst of audio calibration signals. The calibration signals may be played back sequentially or simultaneously. The calibration signals may be audible or subaudible. In some examples, audible calibration signals may be configured to sound like the noise that analogue televisions would emit when changing a channel. The calibration signal may or may not be a DSSS signal, depending on the particular implementation.

According to some examples, there are three unknowns and therefore Nᵤ=3. The unknows are the position of the user and the clock offset of the remote control. These can be placed into a state vector X, as follows:

$$X = {[ {U}_{x} , {U}_{y} , b ]}^{T}$$

In some such examples, the control system is only measuring the range pᵢ from each of the i loudspeakers, so Nₒ=Nₛ. Thus, if there are at least 3 loudspeakers in the system the control system can solve for the user position using the iterative methods mentioned in the “Deriving Absolute Time of Flight Using a Second Set of Measurements” section, for example. If there are fewer than 3 loudspeakers, the control system can still make ambiguous estimates of the user position. The control system may, for example, also use estimates of the user position made during the calibration process to resolve this ambiguity. Some examples may be based, in part, on an assumption that the user is sitting at the same distance from the wall on which the TV is mounted, as this would correspond to an alternate location on a couch in a typical viewing configuration in which the couch is facing the TV. Some such examples may involve assuming Uy is the same as what is was during the initial calibration process and then only solving for

$$X = {[ {U}_{x} , b ]}^{T} ,$$

which requires just two measured ranges from loudspeakers to solve, meaning Nₛ=2. Alternatively, if such assumptions are not made, then there are two ambiguous solutions for the user position U when we have only Nₛ=2. In some such cases, the control system may be configured to calibrate for both of these positions, to calibrate for some average of the two, or to use heuristics to determine which of the two candidate solutions is to be used.

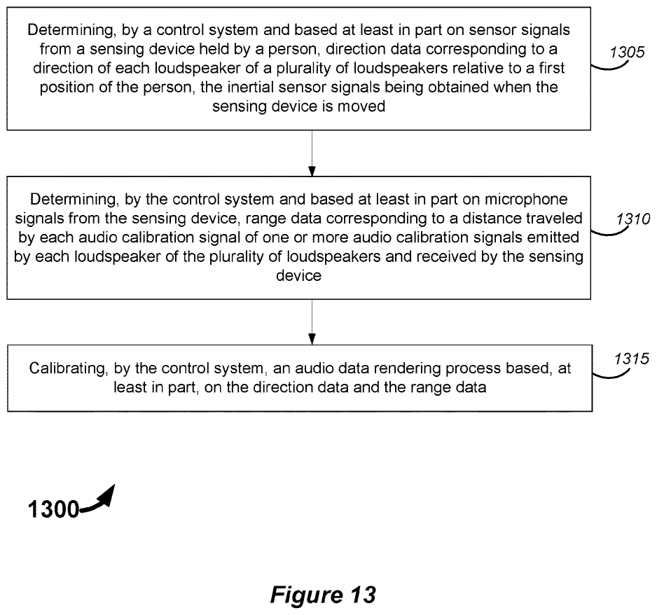

FIG. 13 is a flow diagram that outlines another example of a disclosed method. The blocks of method 1300, like other methods described herein, are not necessarily performed in the order indicated. Moreover, such methods may include more or fewer blocks than shown and/or described. The method 1300 may be performed by an apparatus or system, such as the apparatus 100 that is shown in FIG. 1B and described above.

In this example, block 1305 determining, by a control system and based at least in part on sensor signals from a sensing device held by a person, direction data corresponding to a direction of each loudspeaker of a plurality of loudspeakers relative to a first position of the person. According to this example, the sensor signals are obtained when the sensing device is moved. For example, the sensor signals may be obtained when the sensing device 100 is pointed in the direction of a loudspeaker, when the sensing device is rotated from the direction of one loudspeaker to the direction of another loudspeaker, when the sensing device is translated from the direction of one loudspeaker to the direction of another loudspeaker, or combinations thereof. The sensor signals may be, or may include, magnetometer signals, inertial sensor signals, radio signals, camera signals, or combinations thereof.

According to this example, block 1310 involves determining, by the control system and based at least in part on microphone signals from the sensing device, range data corresponding to a distance travelled by each audio calibration signal of one or more audio calibration signals emitted by each loudspeaker of the plurality of loudspeakers and received by the sensing device. Determining the range data may involve determining a time of arrival of each audio calibration signal of the one or more audio calibration signals emitted by each loudspeaker of the plurality of loudspeakers and received by the sensing device, determining a level of each audio calibration signal of one or more audio calibration signals emitted by each loudspeaker of the plurality of loudspeakers and received by the sensing device, or both.

In this example, block 1315 involves calibrating, by the control system, an audio data rendering process based, at least in part, on the direction data and the range data. In some examples, the audio data rendering process may be, or may include, a flexible rendering process. The flexible rendering process may be, or may include, a center of mass amplitude panning process, a flexible virtualization process, a vector base amplitude panning process, or combinations thereof.

According to some examples, the direction may be the direction of a loudspeaker relative to a direction in which the person is estimated to be facing. In some examples, the direction in which the person is estimated to be facing corresponds to a display location. According to some such examples, the display location may be a television display location, a display monitor location, etc.

In some examples, the one or more audio calibration signals may be simultaneously emitted by two or more loudspeakers. In some such examples, the one or more audio calibration signals may not be audible to human beings. In some examples, the one or more audio calibration signals may be, or may include, DSSS signals. The DSSS signals may, in some examples, utilize orthogonal spreading codes. However, in some alternative examples, the one or more audio calibration signals may not be simultaneously emitted by two or more loudspeakers.

Some examples may involve determining updated direction data and updated range data when a person subsequently interacts with the apparatus 100, e.g., when a person subsequently interacts with a remote control device implementation of the apparatus 100. Some such examples may involve causing, subsequent to a previous calibration process and at a time during which user input is received via the sensing device, each loudspeaker of the plurality of loudspeakers to transmit subaudible DSSS signals. Some such examples may involve determining updated direction data and updated range data based on the subaudible DSSS signals. Some such examples may involve updating a previously-determined position of the person based, at least in part, on the direction data and the range data.

According to some examples, the direction data may be, or may include, azimuth angles relative to the first position of the person. In some examples, the direction data may be, or may include, altitude relative to the first position of the person. According to some examples, the direction data may be determined based, at least in part, on acoustic shadowing caused by the person.

In some examples, the distance between two or more loudspeakers may be known. In some such examples, method 1300 may involve determining an absolute time of flight to the person of the audio calibration signals emitted by each loudspeaker to the first position of the person.

According to some examples, one or more dimensions of a room in which the plurality of loudspeakers resides may be known or assumed. In some such examples, method 1300 may involve determining an absolute time of flight to the person of the audio calibration signals emitted by each loudspeaker to the first position of the person.

In some examples, method 1300 may involve obtaining at least one additional set of direction data and range data at a second position of the person. In some such examples, method 1300 may involve determining an absolute time of flight to the person of the audio calibration signals emitted by each loudspeaker to the first and second positions of the person.

According to some examples, method 1300 may involve determining that the sensing device is pointed in the direction of a loudspeaker at a time during which user input is received via the sensing device. The user input may be, or may include, a mechanical button press or touch sensor data received from a touch sensor. In some examples, method 1300 may involve providing an audio prompt, a visual prompt, a haptic prompt, or combinations thereof, to the person indicating when to provide the user input to the sensing device.

The speed of sound varies with temperature. Therefore, in some examples, method 1300 may involve obtaining temperature data corresponding to the ambient temperature of the audio environment. In some examples, method 1300 may involve determining a current speed of sound corresponding with the ambient temperature of the audio environment and determining the range data according to the current speed of sound. According to some examples, method 1300 may involve obtaining an additional set of direction data and range data responsive to a temperature change in an environment in which the plurality of loudspeakers resides.

In some examples, a device position may be a proxy for a position of the person. Alternatively, according to some examples the position of the person may be based on a known or inferred relationship between the device position and one or more parts of the person's body. In some examples, determining the direction data, the range data, or both, may be based at least in part on one or more known or inferred spatial relationships between the sensing device and a head of the person when the sensor signals and the microphone signals are being obtained.

According to some examples, method 1300 may involve associating an audio calibration signal with a loudspeaker based at least in part on one or more signal-to-noise ratio (SNR) measurements.

In some examples, method 1300 may involve performing a temporal masking process on the microphone signals. In some such examples, performing the temporal masking process on the microphone signals may be based, at least in part, on received orientation data.

According to some examples, method 1300 may involve updating, by the control system, a previously-determined map including loudspeaker locations relative to a position of the person. The updating process may be based, at least in part, on the direction data and the range data.

### Synthetic Aperture

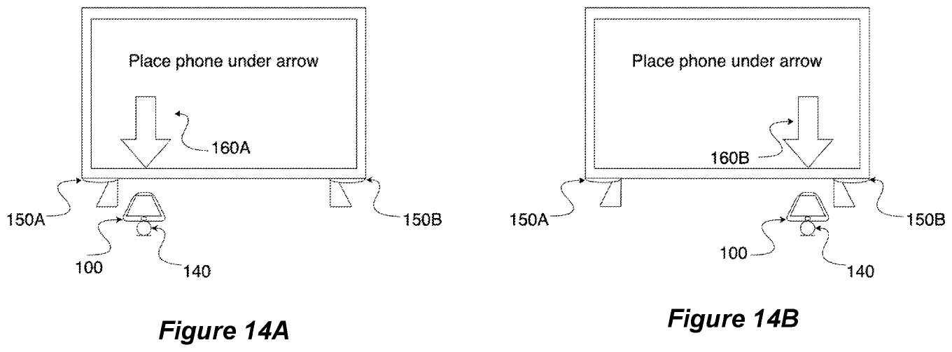

The aforementioned techniques involve an acoustic measurement made at the user position, for example using DSSS signals, coupled with loudspeaker direction data derived from movements of a handheld device. FIGS. 14A and 14B show examples of an alternative approach that involves deriving direction data using at least two acoustic measurements alone, where the location of the handheld device, relative to at least one loudspeaker, is known. The examples shown in FIGS. 14A and 14B involve the placement of a handheld device 100 under a TV at a first position denoted by the onscreen arrow 160A of FIG. 14A, followed by a second measurement at a second position denoted by the onscreen arrow 160B of FIG. 14B. When the handheld device 100 is in the first position shown in FIG. 14A, a distance d_{1,1} is known between microphone 140 and the TV's leftmost speaker 150A. In the second position shown in FIG. 14B, a distance d_{2,2} is known between microphone 140 and the TV's rightmost speaker 150B.

The measured time of arrival T_{i,j}, from speaker i to microphone j, may be expressed as

$${T}_{i , j} = \frac{{d}_{i , j}}{c} + {τ}_{j} ,$$

where τⱼ represents a constant bias on the jth microphone caused by unknown start times of the play and record buffers. The offset τⱼ may therefore be expressed as

$${τ}_{j} = {T}_{i , j} - \frac{{d}_{i , j}}{c} ,$$

which can be calculated from known d and measured T_{i,j}. Multiple estimates of τⱼ can be found and averaged if multiple known d_{i,j} are known.

Consequently, all distances d_{i,j} can be estimated without ambiguity. Let X₀∈ [symbol] ^{M×2} be the locations of the M microphones in Cartesian coordinates. In some examples, the locations of the N loudspeakers X∈ [symbol] ^{N×2} can be found by optimizing

$$\hat{x} = {arg min}_{x} ( {\sum }_{i = 1}^{N} {\sum }_{j = 1}^{M} {( {T}_{i , j} c - \vert {x}_{i} - {x}_{0 j} \vert )}^{2} )$$

where xᵢ and x₀ⱼ represent the ith and jth rows of X and X₀.

### Volumetric Modeling

An alternative implementation may use a camera or depth sensor instead of a microphone for deriving the range of the speakers from the listener position.

Volumetric measurement techniques based upon the fusion of sensor data such as cameras, inertial measurement units (IMUs), and light detection and ranging (LiDAR), have become commonplace in cellphones. In a similar user motion to that of FIG. 1, a model of the 3D space relative to an origin defined by the intended listening position may be created by user movement of the device around the space and deriving a volumetric model using the camera, IMUs and LiDAR. The location of a loudspeaker may be identified by touch input on a display, whereby the user taps a loudspeaker where it appears on the screen. Alternatively, a unique image displayed on the loudspeaker can be identified automatically by image recognition. Alternatively, the shape of the loudspeaker itself can be identified by image recognition. In some implementations, the user's “look at” position may be derived by a user tapping on the display when pointing the sensing device 100 in a particular direction.

Through these volumetric methods the range and direction data of each loudspeaker from the listener position may be derived by assuming the sensing device is at the listening position or using some other model. Like the previous examples, the range can either be a relative range or an absolute range. Some sensors such as LiDAR sensors will output an absolute range. The range and direction data can then be used for configuring a flexible renderer 154. In some examples, the flexible renderer 154 may be configured to implement center of mass amplitude panning (CMAP), flexible virtualization (FV), vector-based amplitude panning (VBAP), another flexible rendering method, or combinations thereof.

Various features and aspects will be appreciated from the following enumerated example embodiments (“EEEs”):
EEE1 An audio processing method, comprising:
   determining, by a control system and based at least in part on sensor signals from a sensing device held or moved by a person, direction data corresponding to a direction of each loudspeaker of a plurality of loudspeakers relative to a first position of the person, the sensor signals being obtained when the sensing device is moved;
   determining, by the control system and based at least in part on sensor signals from the sensing device, the sensor signals including camera signals, range data corresponding to a distance travelled by each audio calibration signal of one or more audio calibration signals emitted by each loudspeaker of the plurality of loudspeakers and received by the sensing device; and
   calibrating, by the control system, an audio data rendering process based, at least in part, on the direction data and the range data.
EEE2 The audio processing method of EEE 1, wherein the audio data rendering process comprises a flexible rendering process.
EEE3 The audio processing method of EEE 2, wherein the flexible rendering process comprises a center of mass amplitude panning process, a flexible virtualization process, a vector base amplitude panning process, or combinations thereof.
EEE4 The audio processing method of any one of EEEs 1-3, wherein the sensor signals comprise magnetometer signals, inertial sensor signals, radio signals, microphone signals, or combinations thereof.
EEE5 The audio processing method of any one of EEEs 1-4, wherein the direction and distance of a loudspeaker relative to a person is determined when the user identifies a loudspeaker by tapping an on-screen camera feed, wherein the tap location corresponds to a point in a volumetric model of the environment.
EEE6 The audio processing method of any one of EEEs 1-4, wherein the direction and distance of a loudspeaker relative to a person is determined when a loudspeaker is identified by image recognition, wherein the identified image corresponds to a point in a volumetric model of the environment.
EEE7 The method of any one of EEEs 1-4, wherein sensor data corresponding to first position is captured at a known position relative to a television (TV), and sensor data corresponding to a second position is captured at a different known location relative to the TV.

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system may be implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. An audio processing method, comprising:
determining, by a control system and based at least in part on sensor signals from a sensing device held or moved by a person, direction data corresponding to a direction of each loudspeaker of a plurality of loudspeakers relative to a first position of the person, the sensor signals being obtained when the sensing device is moved;
determining, by the control system and based at least in part on microphone signals from the sensing device, range data corresponding to a distance travelled by each audio calibration signal of one or more audio calibration signals emitted by each loudspeaker of the plurality of loudspeakers and received by the sensing device; and
calibrating, by the control system, an audio data rendering process based, at least in part, on the direction data and the range data.

2. The audio processing method of claim 1, wherein the audio data rendering process comprises a flexible rendering process.

3. The audio processing method of claim 2, wherein the flexible rendering process comprises a center of mass amplitude panning process, a flexible virtualization process, a vector base amplitude panning process, or combinations thereof.

4. The audio processing method of claim 1, wherein the sensor signals comprise magnetometer signals, inertial sensor signals, radio signals, camera signals, or combinations thereof.

5. The audio processing method of claim 1, wherein the direction is the direction of a loudspeaker relative to a direction in which the person is estimated to be facing.

6. The audio processing method of claim 5, wherein the direction in which the person is estimated to be facing corresponds to a display location.

7. The audio processing method of claim 1, wherein the one or more audio calibration signals are simultaneously emitted by two or more loudspeakers.

8. The audio processing method of claim 7, wherein the one or more audio calibration signals are not audible to human beings.

9. The audio processing method of claim 7, wherein the one or more audio calibration signals are, or include, direct sequence spread spectrum (DSSS) signals utilizing orthogonal spreading codes.

10. (canceled)

11. The audio processing method of claim 1, wherein the direction data are, or include, azimuth angles relative to the first position of the person.

12. The audio processing method of claim 1, wherein the direction data are, or include, altitude relative to the first position of the person.

13-16. (canceled)

17. The audio processing method of claim 1, further comprising determining that the sensing device is pointed in the direction of a loudspeaker at a time during which user input is received via the sensing device.

18. (canceled)

19. The audio processing method of claim 17, further comprising providing an audio prompt, a visual prompt, a haptic prompt, or combinations thereof, to the person indicating when to provide the user input to the sensing device.

20. The audio processing method of claim 1, further comprising obtaining an additional set of direction data and range data responsive to a temperature change in an environment in which the plurality of loudspeakers resides.

21. The audio processing method of claim 1, wherein determining the direction data, the range data, or both, is based at least in part on one or more known or inferred spatial relationships between the sensing device and a head of the person when the sensor signals and the microphone signals are being obtained.

22. The audio processing method of claim 1, further comprising associating an audio calibration signal with a loudspeaker based at least in part on one or more signal-to-noise ratio (SNR) measurements.

23. The audio processing method of claim 1, further comprising performing a temporal masking process on the microphone signals based, at least in part, on received orientation data.

24. The audio processing method of claim 1, further comprising updating, by the control system, a previously-determined map including loudspeaker locations relative to a position of the person based, at least in part, on the direction data and the range data.

25. The audio processing method of claim 1, wherein the sensor signals are obtained when the sensing device is pointed in the direction of a loudspeaker, when the sensing device is rotated from the direction of one loudspeaker to the direction of another loudspeaker, when the sensing device is translated from the direction of one loudspeaker to the direction of another loudspeaker, or combinations thereof.

26. The audio processing method of claim 1, wherein determining the range data involves determining a time of arrival of each audio calibration signal of the one or more audio calibration signals emitted by each loudspeaker of the plurality of loudspeakers and received by the sensing device, determining a level of each audio calibration signal of one or more audio calibration signals emitted by each loudspeaker of the plurality of loudspeakers and received by the sensing device, or both.

27-28. (canceled)

29. One or more non-transitory computer-readable media having instructions stored thereon to control one or more devices to perform operations of claim 1.

30. (canceled)

31. A system comprising:
a control system configured to:
determine, based at least in part on sensor signals from a sensing device held or moved by a person, direction data corresponding to a direction of each loudspeaker of a plurality of loudspeakers relative to a first position of the person, the sensor signals being obtained when the sensing device is moved,
determine, based at least in part on microphone signals from the sensing device, range data corresponding to a distance travelled by each audio calibration signal of one or more audio calibration signals emitted by each loudspeaker of the plurality of loudspeakers and received by the sensing device, and
calibrate an audio data rendering process based, at least in part, on the direction data and the range data.
